(19) United States
(12) Patent Application Publication
(10) Pub. No.: US 2024/0341441 A1
(43) Pub. Date: Oct. 17, 2024

(54) ATTACHMENTS AND DRYING APPARATUSES HAVING THE ATTACHMENTS

(71) Applicant: SZ ZUVI TECHNOLOGY CO., LTD., Shenzhen (CN)

(72) Inventors: Lingdong GU, Shenzhen (CN); Zhao TONG, Shenzhen (CN); Chufeng LIU, Shenzhen (CN)

(73) Assignee: SZ ZUVI TECHNOLOGY CO., LTD., Shenzhen (CN)

(21) Appl. No.: 18/757,392

(22) Filed: Jun. 27, 2024

Related U.S. Application Data
(63) Continuation of application No. PCT/CN2021/144037, filed on Dec. 31, 2021.

(51) Int. Cl. A45D 20/12

(52) U.S. Cl. CPC A45D 20/122; A45D 2200/205

(57) ABSTRACT

The present disclosure directs to an attachment configured to be operably coupled to a drying apparatus that includes a radiation energy source assembly. The attachment may have a radiation inlet and a radiation outlet. The attachment may include a radiation adjusting assembly configured to output second radiation through the radiation outlet by adjusting at least one radiation parameter of first radiation. The first radiation may be generated by the radiation energy source assembly of the drying apparatus and enter the attachment through the radiation inlet, and a radiation power of the first radiation may be at least 5 watts.

### CROSS-REFERENCE TO RELATED APPLICATIONS

This application is a Continuation of International Application No. PCT/CN2021/144037, filed on Dec. 31, 2021, the contents of which are incorporated herein by reference.

### TECHNICAL FIELD

The present disclosure generally relates to an apparatus for drying an object, and more particularly, relates to an attachment for the apparatus for drying an object.

### BACKGROUND

A traditional drying apparatus (e.g., a blow dryer) may blow hot air to dry a wet object (e.g., hair). Such a traditional drying apparatus may extract ambient temperature air in and heat the airflow. A traditional attachment (e.g., a nozzle) can be attached to the traditional drying apparatus and guide the airflow generated by the traditional drying apparatus. A drying apparatus based on radiation energy can emit radiation to dry the object. For example, the drying apparatus based on radiation energy can emit infrared radiation to the object to facilitate the drying of the object. However, if a traditional attachment is used with such a drying apparatus, the radiation may be substantially blocked by the traditional attachment. In addition, the blocked radiation may cause local overheat of the traditional attachment and/or the drying apparatus, or a portion thereof, which in turn may damage the traditional attachment, the drying apparatus, and/or harm a user thereof. Therefore, it is desirable to develop an attachment to be used with a drying apparatus with improved efficiency and/or safety.

### SUMMARY

According to a first aspect of the present disclosure, an attachment is provided. The attachment may be configured to be operably coupled to a drying apparatus that includes a radiation energy source assembly. The attachment may have a radiation inlet and a radiation outlet. The attachment may include a radiation adjusting assembly configured to output second radiation through the radiation outlet by adjusting at least one radiation parameter of first radiation. The first radiation may be generated by the radiation energy source assembly of the drying apparatus and enter the attachment through the radiation inlet, and a radiation power of the first radiation may be at least 5 watts.

In some embodiments, the at least one radiation parameter of the first radiation may include a radiation energy density, a radiation path, a radiation field distribution, spectrum, or the like, or any combination thereof.

In some embodiments, a degree of uniformity of the second radiation may be improved over a degree of uniformity of the first radiation.

In some embodiments, a ratio of an area of the radiation outlet to an area of the radiation inlet may be in a range from 0.1 to 10.

In some embodiments, at least one of the first radiation or the second radiation may include radiation components in a wavelength range from 0.4 to 10 micrometers.

In some embodiments, the at least one radiation parameter of the first radiation may be adjusted by the radiation adjusting assembly by a process including reflection, refraction, absorption, transmission, diffraction, dispersion, waveguiding, or the like, or any combination thereof.

In some embodiments, at least a portion of the radiation adjusting assembly may be located on a radiation path of the attachment.

In some embodiments, radiation power of the first radiation may be at least 50% of radiation power of radiation generated by the radiation energy source assembly of the drying apparatus.

In some embodiments, the drying apparatus may further include an airflow generating assembly configured to generate an airflow, and the attachment may further include an airflow adjusting assembly. The airflow adjusting assembly may be configured to provide an airflow path having an airflow inlet and an airflow outlet, or the airflow adjusting assembly may include an airflow guiding sub-assembly.

In some embodiments, at least one of the airflow path or the airflow adjusting assembly may be configured to adjust at least one first airflow parameter of the airflow that enters the attachment via the airflow inlet.

In some embodiments, the at least one first airflow parameter of the airflow may include a flow rate, a velocity, a direction of the airflow at the airflow outlet, temperature, humidity, a composition of the airflow, or the like, or any combination thereof.

In some embodiments, cross sections of the airflow path may be configured to adjust the at least one first airflow parameter of the airflow.

In some embodiments, the airflow path may be formed by an inner wall of the attachment.

In some embodiments, the airflow guiding sub-assembly may be configured to adjust at least one second airflow parameter of the airflow.

In some embodiments, the at least one second airflow parameter of the airflow may include a velocity or, a direction, temperature, humidity, a composition of the airflow, or the like, or any combination thereof.

In some embodiments, the airflow guiding sub-assembly may include an airflow channel through which at least a portion of the airflow traverses, and cross sections of the airflow channel may be configured to adjust the at least one second airflow parameter of the at least a portion of the airflow.

In some embodiments, a ratio of a radiation energy density of the second radiation to a radiation energy density of the first radiation may be less than 0.1.

In some embodiments, a ratio of the radiation power of the second radiation to the radiation power of the first radiation may be less than 0.2.

In some embodiments, at least a portion of the first radiation may be consumed to heat the airflow.

In some embodiments, the at least a portion of the first radiation may be consumed to heat the airflow by a process including at least one of reflection or absorption.

In some embodiments, the at least a portion of the first radiation consumed to heat the airflow may be at least 50% of the first radiation.

In some embodiments, the radiation adjusting assembly may be arranged on an inner wall of the attachment.

In some embodiments, at least a portion of the radiation adjusting assembly may be arranged on an inner surface of the airflow path.

In some embodiments, the at least a portion of the radiation adjusting assembly may include a radiation-absorbing material.

In some embodiments, the airflow path may narrow gradually from the airflow inlet to the airflow outlet of the airflow path.

In some embodiments, a ratio of a radiation energy density of the second radiation to a radiation energy density of the first radiation may be in a range from 1.2 to 10.

In some embodiments, a ratio of the radiation power of the second radiation to the radiation power of the first radiation may be at least 0.2.

In some embodiments, at least a portion of the radiation adjusting assembly may be arranged on an inner surface of the airflow path.

In some embodiments, at least a portion of the radiation adjusting assembly may be arranged on an outer wall of the airflow guiding sub-assembly facing an inner surface of the airflow path.

In some embodiments, the at least a portion of the radiation adjusting assembly may include a radiation-reflecting material.

In some embodiments, the airflow guiding sub-assembly may include a guiding surface that narrows gradually in a direction from the airflow inlet to the airflow outlet of the airflow path.

In some embodiments, a ratio of a radiation energy density of the second radiation to a radiation energy density of the first radiation may be in a range from 0.5 to 1.5.

In some embodiments, a ratio of the radiation power of the second radiation to the radiation power of the first radiation may be at least 0.5.

In some embodiments, the airflow path may expand gradually from the airflow inlet to the airflow outlet of the airflow path.

In some embodiments, the radiation adjusting assembly may be arranged as an integral part of the attachment.

In some embodiments, the radiation adjusting assembly may include a radiation-permeable cover arranged at the radiation outlet.

In some embodiments, the airflow guiding sub-assembly may include a grille for guiding at least a portion of the airflow toward a region of the radiation outlet.

In some embodiments, the grille may have a shape of a cone, and a portion of the radiation-permeable cover may have a convex shape to receive the grille.

In some embodiments, the radiation-permeable cover may have a uniform thickness.

In some embodiments, the radiation-permeable cover may include a plurality of first openings for guiding at least a portion of the airflow exiting the attachment.

In some embodiments, the radiation-permeable cover may include a plurality of columns each of which may provide a second opening for guiding at least a portion of the airflow exiting the attachment at an exit direction.

In some embodiments, at least two of the plurality of columns may be configured such that the exit directions are different.

In some embodiments, the airflow adjusting assembly or the airflow guiding sub-assembly may include a radiation-permeable material.

In some embodiments, a ratio of the radiation power of the second radiation to the radiation power of the first radiation may be at least 0.8.

In some embodiments, the airflow guiding sub-assembly may include a guiding column that is configured with a surface expanding gradually in a direction from the airflow inlet to the airflow outlet.

In some embodiments, at least a portion of the radiation adjusting assembly may be arranged on a surface of the airflow guiding sub-assembly.

In some embodiments, the surface of the airflow guiding sub-assembly on which the at least a portion of the radiation adjusting assembly is arranged may be located on the radiation path of the first radiation.

In some embodiments, the surface of the airflow guiding sub-assembly on which the at least a portion of the radiation adjusting assembly is arranged may face the radiation energy source assembly.

In some embodiments, the at least a portion of the radiation adjusting assembly may include a radiation-reflecting material coated on the surface of the airflow guiding sub-assembly.

In some embodiments, at least a portion of the airflow guiding sub-assembly may include a radiation-permeable material.

In some embodiments, the at least a portion of the airflow guiding sub-assembly may be located on the radiation path of the first radiation.

In some embodiments, the radiation adjusting assembly may include a waveguide.

In some embodiments, the airflow guiding sub-assembly may be arranged in the airflow path.

In some embodiments, at least one of the radiation outlet or the airflow outlet may be configured as a grille.

In some embodiments, the radiation inlet may be arranged around the airflow inlet.

In some embodiments, the radiation outlet may be arranged around the airflow outlet.

In some embodiments, the radiation inlet and the airflow inlet may at least partially overlap.

In some embodiments, the radiation outlet and the airflow outlet may at least partially overlap.

In some embodiments, the attachment may further include a connecting assembly configured to operably connect the attachment to the drying apparatus.

In some embodiments, the attachment may be attached to a housing of the drying apparatus by the connecting assembly.

In some embodiments, the connecting assembly may include a magnet.

According to a second aspect of the present disclosure, a drying apparatus is provided. The drying apparatus may include a radiation energy source assembly configured to provide first radiation, and an attachment of the present disclosure configured to output second radiation by adjusting at least one radiation parameter of the first radiation.

According to a third aspect of the present disclosure, a drying apparatus is provided. The drying apparatus may include a radiation energy source assembly configured to provide first radiation and a housing in which the radiation energy source assembly is located. The housing may be configured to be operably coupled to an attachment of the present disclosure that is configured to output second radiation by adjusting at least one radiation parameter of the first radiation.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary drying apparatus100 according to some embodiments of the present disclosure;

FIG. 2 is a block diagram illustrating an exemplary attachment 200 according to some embodiments of the present disclosure;

FIG. 3 is a schematic diagram illustrating an exemplary process for adjusting at least one radiation parameter of first radiation by an exemplary attachment 302 according to some embodiments of the present disclosure;

FIG. 4 is a schematic diagram illustrating an exemplary process for adjusting at least one radiation parameter of first radiation by an exemplary attachment 402 according to some embodiments of the present disclosure;

FIGS. 5A-5D provide schematic diagrams illustrating exemplary airflow guiding sub-assemblies according to some embodiments of the present disclosure;

FIGS. 6A and 6B provide views of an exemplary attachment 600 according to some embodiments of the present disclosure;

FIG. 7 provides a radial view of a radiation energy density distribution of radiation generated by a radiation energy source assembly 104 of the dry apparatus 100 according to some embodiments of the present disclosure;

FIG. 8 provides a radial view of a radiation energy density distribution of second radiation at an airflow outlet 604 of the attachment 600 illustrated in FIGS. 6A and 6B according to some embodiments of the present disclosure;

FIGS. 9A and 9B provide views of an exemplary attachment 900 according to some embodiments of the present disclosure;

FIG. 10 provides a radial view of a radiation energy density distribution of second radiation at a radiation outlet 906 of the attachment 900 illustrated in FIGS. 9A and 9B according to some embodiments of the present disclosure;

FIGS. 11A-11C provide views of an exemplary attachment 1100 according to some embodiments of the present disclosure;

FIG. 12 provides a radial view of a radiation energy density distribution of second radiation at a radiation outlet 1160 of the attachment 1100 illustrated in FIGS. 11A-11C according to some embodiments of the present disclosure; and

FIGS. 13A and 13B provide views of an exemplary attachment 1300 according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “unit,” “module,” and/or “block” used herein are one method to distinguish different components, elements, parts, sections, or assembly of different levels in ascending order. However, the terms may be displaced by another expression if they achieve the same purpose.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present unless the context clearly indicates otherwise. As used herein, the term “and/or” includes any and all combinations of one or more of the associated listed items.

In addition, it should be understood that in the description of the present disclosure, the terms “first,” “second,” or the like, are only used for the purpose of differentiation, and cannot be interpreted as indicating or implying relative importance, nor can be understood as indicating or implying the order.

Notwithstanding that the numerical ranges and parameters setting forth the broad scope of the invention are approximations, the numerical values set forth in the specific examples are provided as precisely as possible. Any numerical value, however, inherently contains certain errors necessarily resulting from the standard deviation found in their respective testing measurements. Every numerical range given throughout this specification will include every narrower numerical range that falls within such broader numerical range as if such narrower numerical ranges were all expressly written herein.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

According to an aspect of the present disclosure, an attachment is provided. The attachment may be operably coupled to a drying apparatus that includes a radiation energy source assembly. The radiation energy source assembly may generate radiation of a certain radiation power to dry an object (e.g., hair). The attachment may have a radiation inlet and a radiation outlet. At least a portion of the radiation (e.g., first radiation) generated by the drying apparatus may enter the attachment through the radiation inlet. The attachment may include a radiation adjusting assembly configured to output second radiation through the radiation outlet by adjusting at least one radiation parameter of the first radiation. Merely by way of example, the at least one radiation parameter of the first radiation may include a radiation energy density, a radiation path, a radiation field distribution, spectrum, or the like, or any combination thereof. Through the radiation adjusting assembly, the attachment may utilize or guide the first radiation effectively to adapt to the needs of different scenarios.

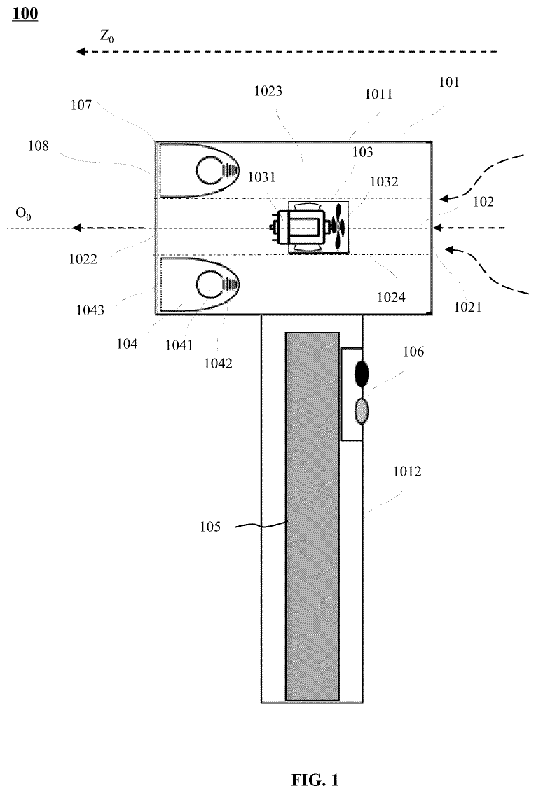

FIG. 1 is a schematic diagram of an exemplary drying apparatus 100 according to some embodiments of the present disclosure. The drying apparatus 100 may be configured to dry an object (e.g., food, clothes, garment, paper, hair, hands, body, etc.). For instance, the drying apparatus 100 may be a hair dryer for drying the hair of a person. As illustrated in FIG. 1, the drying apparatus 100 may include a housing 101, an airflow channel 102, an airflow generating assembly 103, a radiation energy source assembly 104, and a power assembly 105.

The housing 101 may accommodate one or more of the exemplified components of drying apparatus 100 (e.g., the airflow channel 102, the airflow generating assembly 103, the radiation energy source assembly 104, and/or the power assembly 105). The housing 101 may be made of an electrically insulating material having a high resistance for electrical flows.

Examples of the electrically insulating material may include polyvinyl chloride (PVC), polyethylene terephthalate (PET), acrylonitrile-butadiene-styrene copolymer (ABS), polyester, polyolefins, polystyrene, polyurethane, thermoplastic, silicone, glass, fiberglass, resin, rubber, ceramic, nylon, and wood. The housing 101 may also be made of a metallic material coated with an electrically insulating material or a combination of an electrically insulating material and metallic material coated or not coated with an electrically insulating material. For example, the electrically insulating material may form an inner layer of the housing 101, while the metallic material may form an outer layer of the housing 101.

The airflow channel 102 may be disposed in the housing 101 and configured to direct and/or regulate an airflow therein. The airflow channel 102 may be defined by the wall 1024. The airflow channel 102 may include an airflow inlet 1021 and an airflow outlet 1022. The airflow inlet 121 and the airflow outlet 122 may be located at different ends of the drying apparatus 100.

The airflow generating assembly 103 may generate the airflow in the airflow channel 102. The airflow may facilitate an evaporation of water from the object. The airflow generating assembly 103 may include a motor 1031 and an impeller 1032. The motor 1031 may be a direct current (DC) motor, an alternating current (AC) motor, etc. Exemplary DC motors may include brushless DC motors, electrically excited DC motors (e.g., separately excited DC motors, series DC motors, shunt DC motors, compound DC motors, etc.), permanent magnet (PM) DC motors, etc. Exemplary AC motors may include brushless AC motors, AC commutator series motors, repulsion motors, induction motors, asynchronous motors, synchronous motors, etc.

The motor 1031 may include a stator and a rotor. The stator may include one or more components being stationary in the motor 1031. In some embodiments, the stator may generate a magnetic field. The magnetic field may distribute at a position where the rotor is located. In some embodiments, the stator may include an iron core and windings wrapping the iron core. Alternatively, the stator may include a permanent magnet.

The rotor may be configured to rotate around a rotation axis of the motor 1031. In some embodiments, the rotor may include at least one conducting wire. When electric power is supplied to the motor 1031, an electric current may be formed in the at least one conducting wire of the rotor. The rotor, which is located in the magnetic field generated by the stator, may be driven to rotate around the rotation axis of the motor 1031 after the electric current is formed in the at least one conducting wire.

The impeller 1032 may include a plurality of blades. The impeller 1032 may be operably coupled to the rotor so as to effect the airflow in the airflow channel 102 when the rotor rotates. In some embodiments, the impeller 1032 may be operably coupled to the rotor through a physical connection. Exemplary physical connections may include a threaded connection, a flanged connection, a snap-fit connection, an adhesive connection, etc. The impeller 1032 may be fixedly connected to the rotor through the physical connection, such that the impeller 1032 may rotate along with the rotor. In such cases, the plurality of blades may effect the airflow in the airflow channel 102 when the rotor rotates.

In some embodiments, the motor 1031 may be a high-speed motor. The high-speed motor may have specific features relating to, for example, a rotating speed of the motor 1031, a count of the plurality of blades of the impeller 1032, a blade-passing frequency (BPF) associated with the impeller 1032, and/or a velocity of the airflow in the airflow channel 102. In some embodiments, the rotating speed of the motor 1031 may exceed 50,000 revolutions per minute (RPM). For instance, the rotating speed of the motor 1031 may be 60,000 RPM, 70,000 RPM, 80,000 RPM, 90,000 RPM, 100,000 RPM, 110,000 RPM, 120,000 RPM, 150,000 RPM, etc. In some embodiments, the count of the plurality of blades of the impeller 1032 may exceed 5. For instance, the count of the plurality of blades may be 6, 7, 8, 9, 10, 11, 12, 13, 14, 15, 16, 17, etc. Further, the count of the plurality of blades of the impeller 1032 may be a prime number. For instance, the count of the plurality of blades may be 7, 11, 13, 17, etc. In addition, the BPF associated with the impeller 1032 may be substantially within an ultrasonic frequency range. The BPF refers to a rate at which the plurality of blades of the impeller 1032 pass by a fixed position. The BPF is correlated to a product of a rotating speed of the motor 1031 and the count of the plurality of blades of the impeller 1032.

In some embodiments, the housing 101 may include a main portion 1011 and an auxiliary portion 1012. The auxiliary portion 1012 may be connected with the main portion 1011. A length direction of the main portion 1011 may intersect with a length direction of the auxiliary portion 1012. Illustratively, as shown in FIG. 1, the length direction of the main portion 1011 may be along an axial direction Z₀ thereof. The length direction of the main portion 1011 may be substantially perpendicular to the length direction of the auxiliary portion 1012. In some embodiments, the angle between the length direction of the main portion 1011 and the length direction of the auxiliary portion 1012 may be adjustable. In some embodiments, the angle between the length direction of the main portion 1011 and the length direction of the auxiliary portion 1012 may be adjusted within a range, e.g., between 0° and 90°, or between 10° and 90°, or between 0° and 180°. For instance, the auxiliary portion 1012 may fold with respect to the main portion 1011 such that the angle between the length direction of the main portion 1011 and the length direction of the auxiliary portion 1012 changes to 0°. As for a hair dryer, the main portion 1011 may be a body of the hair dryer, while the auxiliary portion 1012 may be a handle of the hair dryer.

In some embodiments, the entire airflow channel 102 may be disposed in the main portion 1011. The airflow channel 102 may be, e.g., a straight circular channel that traverses the main portion 1011 along the axial direction Z₀. The airflow inlet 1021 and the airflow outlet 1022 may be located at opposite ends of the main portion 1011 of the drying apparatus 100.

The airflow generating assembly 103 may be arranged in the airflow channel 102 (i.e., the airflow generating assembly 103 may be disposed in the main portion 1011). The airflow generating assembly 103 may be fixed in the airflow channel 102 by a holder or a shroud. A diameter of the airflow channel 102 in the main portion 1011 may be larger than or equal to an outer diameter of the airflow generating assembly 103. The diameter of the airflow channel 102 refers to a diameter of the wall 1024 of the airflow channel 102. In some embodiments, a diameter of the impeller 1032 may be larger than a diameter of a shell of the motor 1031. The outer diameter of the airflow generating assembly 103 may be a diameter of the impeller 1032.

In some other embodiments, the airflow channel 102 may include two segments including a first segment and a second segment. The first segment and the second segment may be disposed in the main portion 1011 and the auxiliary portion 1012 of the housing 101, respectively. The first segment and the second segment of the airflow channel 102 may be in a fluid communication. The first segment of the airflow channel 102 may be, e.g., a straight circular channel that extends in at least a portion of the main portion along the axial direction Z₀. The second segment of the airflow channel 102 may be, e.g., a straight circular channel that extends in at least a portion of the auxiliary portion 1012 along a direction perpendicular to the axial direction Z₀. The airflow inlet 1021 may be located at a lower end of the auxiliary portion 1012. The airflow outlet 1022 may be located at a front end of the main portion 1011 along the axial direction Z₀. The second segment may intersect with the first segment at a position in the main portion 1011.

In some embodiments, the airflow generating assembly 103 may be arranged in the second segment of the airflow channel 102 (i.e., the airflow generating assembly 103 may be disposed in the auxiliary portion 1012). The airflow generating assembly 103 may be fixed in the second segment of the airflow channel 102 by a holder or a shroud. A diameter of the airflow channel 102 in the auxiliary portion 1012 may be larger than or equal to the outer diameter of the airflow generating assembly 103 (e.g., the diameter of the impeller 1032).

In some embodiments, the motor 1031 may be disposed at a central portion of the second segment of the airflow channel 102 in the auxiliary portion 1012. In some embodiments, an axis of the motor 1031 may substantially coincide with the axis of the second segment of the airflow channel 102 in the auxiliary portion 1012 (i.e., the motor may be disposed substantially coaxially with the second segment of the airflow channel 102 in the auxiliary portion 1012). In some embodiments, the axis of the motor 1031 may substantially coincide with the rotation axis of the motor 1031.

In some embodiments, the drying apparatus 100 may include one or more auxiliary airflow channels (not shown). In some embodiments, each auxiliary airflow channel may include an airflow inlet and an airflow outlet. The airflow inlet(s) of at least one of the one or more auxiliary airflow channels and the airflow inlet 1021 of the airflow channel 102 may be located at different portions of the drying apparatus 100. For example, the airflow inlet 1021 of the airflow channel 102 may be located on the main portion 1011 of the housing 101; the airflow inlet(s) of at least one of the one or more auxiliary airflow channels may be located on the auxiliary portion 1012 of the housing 101. In some embodiments, the airflow inlet(s) of at least one of the one or more auxiliary airflow channels and the airflow inlet 1021 of the airflow channel 102 may be located at the same portion of the drying apparatus 100. For example, the airflow inlet(s) of at least one of the one or more auxiliary airflow channels and the airflow inlet 1021 of the airflow channel 102 may be located on the main portion 1011 of the housing 101 or auxiliary portion 1012 of the housing 101. In some embodiments, the airflow inlets, including the airflow inlet(s) of at least one of the one or more auxiliary airflow channels and the airflow inlet 1021 of the airflow channel 102, may be located at different ends of the drying apparatus 100. For example, at least one airflow inlet (e.g., the airflow inlet 1021 of the airflow channel 102) may be located at an end of the main portion 1011 of the housing 101; and at least one airflow inlet (the airflow inlet(s) of at least one of the one or more auxiliary airflow channels) may be located at an end of the auxiliary portion 1012 of the housing 101 (e.g., an end of the auxiliary portion 1012 away from the main portion 1011). In some embodiments, the airflow inlet(s) of at least one of the one or more auxiliary airflow channels and the airflow inlet 1021 of the airflow channel 102 may be located at the same end of the drying apparatus 100. In some embodiments, the airflow outlet(s) of at least one of the one or more auxiliary airflow channels and the airflow outlet 1022 of the airflow channel 102 may be located at different portions of the drying apparatus 100. For example, the airflow outlet 1022 of the airflow channel 102 may be located on the main portion 1011 of the housing 101; the airflow outlet(s) of at least one of the one or more auxiliary airflow channels may be located on the auxiliary portion 1012 of the housing 101. In some embodiments, the airflow outlet(s) of at least one of the one or more auxiliary airflow channels and the airflow outlet 1022 of the airflow channel 102 may be located at the same portion of the drying apparatus 100. For example, the airflow outlet 1022 of the airflow channel 102 and the airflow outlet(s) of at least one of the one or more auxiliary airflow channels may be located on the main portion 1011 of the housing 101. In some embodiments, the airflow outlet(s) of at least one of the one or more auxiliary airflow channels and the airflow outlet 1022 of the airflow channel 102 may be located at different ends of the same portion of the drying apparatus 100. In some embodiments, the airflow outlet(s) of at least one of the one or more auxiliary airflow channels and the airflow outlet 1022 of the airflow channel 102 may be located at the same end of the same portion of the drying apparatus 100. In some embodiments, at least one of the one or more auxiliary airflow channels and the airflow channel 102 may share the same airflow outlet (e.g., the airflow outlet 1022). For example, at least one of the auxiliary airflow channels and the airflow channel 102 may be in fluid communication. The airflow(s) may traverse at least one of the one or more auxiliary airflow channels and enter the airflow channel 102 such that the airflow(s) may exit the airflow channel 102 through the airflow outlet 1022.

The radiation energy source assembly 104 may be configured to provide radiation toward an object through a radiation outlet 108. In some embodiments, the radiation outlet 108 and the airflow outlet 1022 of the airflow channel 102 may be arranged in a non-overlapping manner. For example, the airflow outlet 1022 may be a circular region defined by the wall 1024; the radiation outlet 108 may be an annular region wrapping around the airflow outlet 1022. As another example, the radiation outlet 108 may be a circular region; the airflow outlet 1022 may be an annular region wrapping around the radiation outlet 108. As a further example, the radiation outlet 108 may be arranged in juxtaposition to the airflow outlet 1022. As still a further example, the radiation outlet 108 and the airflow outlet 1022 of the airflow channel 102 may be arranged in non-overlapping regions, respectively. As illustrated in FIG. 1, the radiation outlet 108 may be arranged around the airflow outlet 1022 of the airflow channel 102. In some embodiments, the radiation outlet 108 and the airflow outlet 1022 of the airflow channel 102 may at least partially overlap. For instance, the airflow outlet 1022 may be a circular region defined by the housing 101 (when the wall 1024 is absent). The radiation outlet 108 may be an annular region arranged within the airflow outlet 1022. As another example, the drying apparatus 100 may include a plurality of radiation outlets 108 that are distributed in the region where the airflow outlet 1022 is located. As a further example, the drying apparatus 100 may include a plurality of airflow outlets 1022 that are distributed in the region where the radiation outlet 108 is located.

In some embodiments, the radiation power of the radiation provided by the radiation energy source assembly 104 may be at least 5 watts (W), 10 W, 20 W, 30 W, 40 W, 50 W, 60 W, 70 W, 80 W, 90 W, 100 W, 110 W, 130 W, 150 W, 200 W, etc. In some embodiments, a radiation energy density of the radiation at the radiation outlet 108 may be at least 1 kW/m², 2 kW/m², 3 kW/m², 4 kW/m², 5 kW/m², 6 kW/m², 7 kW/m², 8 kW/m², 9 kW/m², 10 kW/m², 20 kW/m², 30 kW/m², 40 kW/m², 50 kW/m², 60 kW/m², 70 kW/m², 80 kW/m², 90 kW/m², 100 kW/m², 108 kW/m², 120 kW/m², 140 kW/m², 160 kW/m², 180 kW/m², 200 kW/m², 220 kW/m², 240 kW/m², 260 kW/m², 280 kW/m², 300 kW/m², 350 kW/m², 400 kW/m², 450 kW/m², 500 kW/m², etc.

The radiation energy source assembly 104 may be configured to generate radiation and direct the radiation to the object. In some embodiments, the radiation energy source assembly 104 may include one or more radiation energy sources. Each radiation energy source may be or include a radiating element which converts electric energy into radiation directed to the object. The radiating element may include an infrared lamp, a filament lamp, an infrared light emitting diode (LED), a laser device (e.g., carbon dioxide laser), ceramics, graphene, etc. In some embodiments, the radiating element may be an infrared lamp. The radiating element may include a radiation emitting member 1041 (also referred to as a radiation emitter) and a radiation energy reflecting member 1042 (also referred to as a reflector). The radiation emitting member 1041 may be configured to emit radiation having a predetermined wavelength. The radiation energy reflecting member 1042 may be configured to reflect the radiation toward the object. In some embodiments, the radiation emitting member 1041 may be located within an interior of the radiation energy reflecting member 1042. In an exemplary example where a laser device is utilized as the radiating element, the radiation energy reflecting member 1042 may not be necessarily needed.

The radiation emitting member 1041 may be a conductive heater (e.g., a heater operated on a metal resistor or a carbon fiber) or a ceramic heater. Exemplary metal resistors may include tungsten filament, Chrome (e.g., an alloy of nickel and chrome, also known as nichrome) filament, etc. Exemplary ceramic heaters may include a positive temperature coefficient (PTC) heater, a metal-ceramic heater (MCH), etc. In some embodiments, the ceramic heater may include metal heating components located inside the ceramics. For example, the ceramic heater may include tungsten located inside silicon nitride or silicon carbide. The radiation emitting member 1041 may be provided in the form of a wire (e.g., filament). The wire may be patterned (e.g., spiral filament) to increase a length and/or surface thereof. The radiation emitting member 1041 may also be provided in the form of a rod. Merely by way of example, the radiation emitting member 1041 may be a silicon nitride rod, a silicon carbide rod, or a carbon fiber rod that has a predetermine diameter and length.

In some embodiments, the radiation emitted by the radiation emitting member 1041 may substantially cover a visible spectrum from 0.4 μm to 0.7 μm and/or an infrared spectrum above 0.7 μm. In some embodiments, the radiation emitted by the radiation emitting member 1041 may substantially cover the infrared spectrum only. For instance, the radiation emitting member 1041, when energized, may emit radiation having a wavelength from 0.7 μm to 20 μm.

A radiation energy density of the radiation emitted by and measured at the exit of the radiation emitting member 1041 may be at least 1 kW/m², 2 kW/m², 3 kW/m², 4 kW/m², 5 kW/m², 6 kW/m², 7 kW/m², 8 kW/m², 9 kW/m², 10 kW/m², 20 kW/m², 30 kW/m², 40 kW/m², 50 kW/m², 60 kW/m², 70 kW/m², 80 kW/m², 90 kW/m², 100 kW/m², 120 kW/m², 140 kW/m², 160 kW/m², 180 kW/m², 200 kW/m², 220 kW/m², 240 kW/m², 260 kW/m², 280 kW/m², 300 kW/m², 350 kW/m², 400 kW/m², 450 kW/m², 500 kW/m², etc.

The radiation energy reflecting member 1042 may regulate the radiation emitted from the radiation emitting member 1041. For instance, the radiation energy reflecting member 1042 may be shaped to reduce a divergence angle of a reflected beam of the radiation. In some embodiments, the radiation energy reflecting member 1042 may have a substantially cone shape as shown in FIG. 1. For instance, an axial view of a reflecting surface of the reflector 1042 may be parabolic. The radiation emitting member 1041 may be located at a focal point of the parabola, such that the reflected beams of radiation may be substantially parallel. Alternatively, the radiation emitting member 1041 may be located at a position different from the focal point of the parabola, such that the reflected beams of radiation may be convergent or divergent. In some embodiments, a position of the radiation emitting member 1041 in the radiation energy reflecting member 1042 may be adjustable. Therefore, a degree of convergence and/or a direction of the reflected beam of radiation may be changed accordingly. The shape of the radiation energy reflecting member 1042 and/or the shape of the radiation emitting member 1041 may be optimized or varied with respective to each other for desired power output at a desired position exterior to the drying apparatus 100.

The inner surface of the radiation energy reflecting member 1042 may be coated with a coating material having a high reflectivity to a wavelength or a range of wavelength of the radiation emitted by the radiation emitting member 1041. For instance, the coating material may have a high reflectivity to a wavelength in both the visible spectrum and the infrared spectrum. A material having a high reflectivity may have a high effectiveness in reflecting radiation energy. Exemplary coating materials may include metallic materials, dielectric materials, etc. The metallic materials may include, for example, gold, silver, aluminum, or the like. In some embodiments, the coating material may have multiple layers of alternating dielectric materials, such as magnesium fluoride, calcium fluoride, etc. The reflectivity of the coated inner surface of the radiation energy reflecting member 1042 may be at least 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5%, 99.6%, 99.7%, 99.8%, 99.9%, etc., of the incident radiation. In some instances, the reflectivity of the coated inner surface of the radiation energy reflecting member 1042 may be substantially 100%, which means that substantially all the radiation emitted by the radiation emitting member 1041 may be reflected toward an exterior of the drying apparatus 100. As a result, a temperature on the inner surface of the radiation energy reflecting member 1042 may substantially not increase even if a temperature of the radiation emitting member 1041 is high.

In some embodiments, the radiating element may further include an optical member 1043. The optical member 1043 may be provided at an opening of the radiation energy reflecting member 1042. The optical member 1043 may abut against the opening of the optical member 1043 in an air-tight manner. The optical member 1043 may include a lens, a reflector, a prism, a grating, a beam splitter, a filter, or a combination thereof, that modifies or redirects the radiation. In some embodiments, the optical member 1043 may be a lens. In some embodiments, the optical member 1043 may be a Fresnel lens. In some embodiments, each radiation energy source may include an optical member 1043. In some embodiments, the one or more radiation energy sources of the radiation energy source assembly 104 may share the same optical member 1043. In some embodiments, the optical member 1043 may constitute the radiation outlet 108.

In some embodiments, the radiation energy source assembly 104 may further include at least one supporting element. Each of the at least one radiating element may be supported by a supporting element. In some embodiments, the supporting element may be a holder or a shroud.

In some embodiments, the radiation energy source assembly 104 may be arranged at the airflow outlet 1022 of the airflow channel 102. In some embodiments, an edge (e.g., the optical member 1043) of each of the one or more radiation energy sources of the radiation energy source assembly 104 in the axial direction Z₀ may be aligned with or close to the airflow outlet 1022 of the airflow channel 102. For example, a distance between the optical member 1043 of each of the one or more radiation energy sources of radiation energy source assembly 104 and the airflow outlet 1022 of the airflow channel 102 in the axial direction Z₀ may be below a threshold distance. The threshold distance may be, e.g., 0.1 centimeters, 0.3 centimeters, 0.5 centimeters, 0.8 centimeters, 1 centimeter, 1.5 centimeters, 2 centimeters, 2.5 centimeters, 3 centimeters, etc.

In some embodiments, as illustrated in FIG. 1, the drying apparatus 100 may include a space 1023 between the housing 101 and the wall 1024 of the airflow channel 102. The space 1023 between the housing 101 and the airflow channel 102 may be formed between an inner surface of the housing 101 and an outer surface of the wall 1024 of the airflow channel 102. The radiation energy source assembly 104 may be arranged in the space 1023. The space 1023 may be an annulus cavity. In some embodiments, the radiation energy source assembly 104 may be arranged in the annulus cavity, e.g., evenly. For example, the radiation energy source assembly 104 may include four radiation energy sources. The four radiation energy sources may be arranged at positions corresponding to angles of 90 degrees, 180 degrees, 270 degrees, and 360 degrees, respectively, along the circumferential direction of the annulus cavity.

In some embodiments, the radiation energy source assembly 104 may be arranged in a plane substantially perpendicular to the axial direction Z₀ in the space 1023. In some embodiments, the plane may be located at or close to the airflow outlet 1022 of the airflow channel 102. In some embodiments, the radiation energy source assembly 104 may be arranged along a periphery (e.g., the outer surface) of the airflow channel 102. Alternatively, the radiation energy source assembly 104 may be arranged along the inner surface of the housing 101. In some embodiments, the radiation energy source assembly 104 may be arranged in the airflow channel 102.

In some embodiments, the wall 1024 may be absent. The airflow channel 102 may be defined by the housing 101. The radiation energy source assembly 104 may be arranged inside the airflow channel 102 along a ring. In some embodiments, the radiation energy source assembly 104 may be arranged along a contour of any shape, such as a triangle, a square, a sector, etc., inside the airflow channel 102. In some embodiments, the radiation energy source assembly 104 may be arranged in an array inside the airflow channel 102. In some embodiments, the radiation energy source assembly 104 may be positioned substantially at a geometrical center of the airflow channel 102. In some embodiments, the radiation energy source assembly 104 may be positioned substantially at a geometrical center of the airflow outlet 1022.

The power assembly 105 may be configured to supply power to the airflow generating assembly 103 and/or the radiation energy source assembly 104. The power assembly 105 may be or include one or more batteries embedded in the housing 101 (e.g., the auxiliary portion 1012). The one or more batteries may include a lithium battery, a lead acid battery, a fuel cell battery, etc. The power assembly 105 may connect to a power switch 106. A user may control a working status of the drying apparatus 100 by connecting or disconnecting the power assembly 105 with the airflow generating assembly 103 and/or the radiation energy source assembly 104 via the power switch 106. In some embodiments, the drying apparatus 100 may be powered with an external power source. The power assembly 105 may include a power adapter that regulates a voltage and/or a current received from the external power source. For instance, the drying apparatus 100 may be energized by a power source of alternating current.

In some embodiments, the drying apparatus 100 may include a connecting assembly 107. An external apparatus may be removably connected to the drying apparatus 100, or a portion thereof (e.g., the housing 101, the airflow channel 102, the radiation energy source assembly 104, etc.) through the connecting assembly 107 of the drying apparatus 100. For example, an attachment described elsewhere in the present disclosure may be removably attached to the drying apparatus 100 through the connecting assembly 107 of the drying apparatus 100. As illustrated in FIG. 1, the connecting assembly 107 of the drying apparatus 100 may be arranged on the housing 101 where such an external apparatus is connected. For example, the connecting assembly 107 of the drying apparatus 100 may be arranged on an outer wall of the housing 101 that is at or in a vicinity of the airflow outlet 1022 of the airflow channel 102 and/or the radiation outlet 108 of the radiation energy source assembly 104. As another example, the connecting assembly 107 of the drying apparatus 100 may be arranged on an inner wall of the housing 101 that is at or in a vicinity of the airflow outlet 1022 of the airflow channel 102 and/or the radiation outlet 108 of the radiation energy source assembly 104. As a further example, the connecting assembly 107 of the drying apparatus 100 may be arranged on an end wall of the housing 101 that is at or in a vicinity of the airflow outlet 1022 of the airflow channel 102 and/or the radiation outlet 108 of the radiation energy source assembly 104. As used herein, an outer wall of a structure (e.g., the housing 101) refers to a wall of the structure that is farther away from a central axis of the structure (e.g., the axis O₀ of the housing 101) than an inner wall of the structure, or faces the exterior of a space enclosed or defined by the structure (e.g., the airflow channel 102 of the drying apparatus 100). As used herein, an inner wall of a structure (e.g., the housing 101) refers to a wall of the structure that is closer to a central axis of the structure (e.g., an axis O₀ of the housing 101) than an outer wall or surface of the structure, or faces the interior of a space enclosed or defined by the structure (e.g., the airflow channel 102 of the drying apparatus 100). As used herein, an end wall of a structure (e.g., the housing 101) refers to a wall of the structure that is between an inner wall and an outer wall of the structure or a wall connecting the inner wall and the outer wall of the structure. In some embodiments, the connecting assembly 107 may be arranged on a component of the drying apparatus 100 other than the housing 101 to facilitate the connection between the attachment and the drying apparatus 100. In some embodiments, the drying apparatus 100 may include a wall 1024 providing the airflow channel 102 for the airflow generated by the airflow generating assembly 103; the connecting assembly 107 may be arranged on the wall 1024 at the airflow outlet 1022 of the airflow channel 102 defined by the wall 1024. Merely by way of example, the connecting assembly 107 may be arranged on a portion (e.g., an outer wall, an inner wall, an end wall, etc.) of the wall 1024 at or in the vicinity of the airflow outlet 1022 of the airflow channel 102. In some embodiments, the connecting assembly 107 may be arranged on the radiation energy source assembly 104. Merely by way of example, the radiation energy source assembly 104 may include a supporting structure enclosing or supporting the one or more radiation energy sources of the radiation energy source assembly 104; the connecting assembly 107 may be arranged on a portion (e.g., an outer wall, an inner wall, an end wall, etc.) of the supporting structure.

In some embodiments, the attachment may be removably attached to the drying apparatus 100 through a threaded connection, a buckle connection, a magnetic connection, a friction type connection, etc. For example, the connecting assembly 107 of the drying apparatus 100 may include a thread portion that is complimentary to a connecting assembly of the attachment including a thread portion such that the attachment may be removably attached to the drying apparatus 100 via the threaded connection. As another example, the connecting assembly 107 of the drying apparatus 100 may include a catch that is configured to hold a connecting assembly of the attachment including a buckle such that the attachment may be removably attached to the drying apparatus 100 through the buckle connection. As a further example, the connecting assembly 107 of the drying apparatus 100 may include a magnet that attracts a connecting assembly of the attachment including a ferromagnetic material or a magnet such that the attachment may be removably attached to the drying apparatus 100 through the magnetic connection. As still a further example, the connecting assembly 107 of the drying apparatus 100 may include a ferromagnetic material that is attracted by a connecting assembly of the attachment including a magnet such that the attachment may be removably attached to the drying apparatus 100 through the magnetic connection. As still a further example, the connecting assembly 107 of the drying apparatus 100 and a connecting assembly of the attachment may be snugly fit together by friction such that the attachment may be removably attached to the drying apparatus 100 through the friction type connection.

The drying apparatus 100 may further include a control element (not shown). The control element may be programmed to control the function of the airflow generating assembly 103, the radiation energy source assembly 104, and/or the power assembly 105. The control element may include one or more hardware processors, such as a microcontroller, a microprocessor, a reduced instruction set computer (RISC), an application-specific integrated circuits (ASICs), an application-specific instruction-set processor (ASIP), a central processing unit (CPU), a physics processing unit (PPU), a microcontroller unit, a digital signal processor (DSP), a field-programmable gate array (FPGA), an advanced RISC machine (ARM), a programmable logic device (PLD), any circuit or processor capable of executing one or more functions, or the like, or any combinations thereof.

In some embodiments, the drying apparatus 100 may also include one or more air filters (not shown). The one or more air filters may be configured to prevent impurities (e.g., dust, hair, a foreign gas, etc.) from entering the airflow channel 102. In some embodiments, the one or more air filters may include meshes, absorbing layers (e.g., foam, activated carbon, etc.), or the like, or a combination thereof. The one or more air filters may be disposed at preset positions (e.g., the airflow inlet 1021 and/or the airflow outlet 1022) in the airflow channel 102. In some embodiments, the one or more air filters may be detachably mounted at the preset positions for the convenience of cleaning and/or maintenance of the drying apparatus 100.

In some embodiments, the drying apparatus 100 may include an airflow guide assembly (not shown in FIG. 1). The airflow guide assembly may be configured to guide at least a portion of the airflow in the airflow channel 102 to a target region. The target region may abut the at least one of the one or more radiation energy sources of the radiation energy source assembly 104. For example, the target region may be located outside and abut the optical member 1043 of the at least one of one or more the radiation energy sources. In some embodiments, a target region may exist outside each of the one or more radiation energy sources. In some embodiments, a target region may exist outside each of a portion of the one or more radiation energy sources. More descriptions of the airflow guide assembly may be found in PCT Application No. PCT/CN2021/101099, the contents of which are hereby incorporated by reference.

In some embodiments, the drying apparatus 100 may include a sound reducing assembly (not shown in FIG. 1). The sound reducing assembly may be configured to reduce at least a portion of sound in the airflow channel 102. The sound may be caused by the airflow in the airflow channel 102 and/or the airflow generating assembly 103. At least a portion of the sound in the airflow channel 102 may be audible for human being, and may cause discomfort of a person being close to the drying apparatus 100, thus also being referred to as noise. In some embodiments, the sound reducing assembly may include a resonance chamber. The resonance chamber may be disposed in the airflow channel 102 to reduce or eliminate at least a portion of the sound (e.g., the noise) in the airflow channel 102. More descriptions of the sound reducing assembly may be found in PCT Application No. PCT/CN2021/101092, the contents of which are hereby incorporated by reference.

It should be noted that the above description regarding the drying apparatus 100 is merely provided for the purposes of illustration, and not intended to limit the scope of the present disclosure. For persons having ordinary skills in the art, multiple variations and modifications may be made under the teachings of the present disclosure. For example, two or more airflow channels may be provided in the housing 101. A sound reducing element may be disposed in each of the two or more airflow channels for reducing sound in the airflow channel. As another example, the drying apparatus 100 may further include one or more components, such as a storage device, a control circuit, one or more sensors, etc. As a further example, the drying apparatus 100 may further include a non-radiative energy source assembly (e.g., a resistive heating element). The non-radiative energy source assembly may be configured to transform electrical energy into heat energy to heat the airflow in the airflow channel 102, which may be used in conjunction with the radiation energy source assembly 104 or separately to adapt to the needs of different scenarios. However, those variations and modifications do not depart from the scope of the present disclosure.

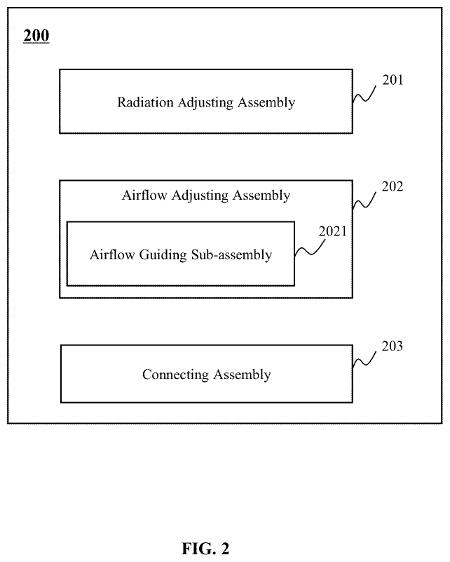

FIG. 2 is a block diagram illustrating an exemplary attachment 200 according to some embodiments of the present disclosure. In some embodiments, the attachment 200 may be configured to be operably coupled to a drying apparatus (e.g., the drying apparatus 100 illustrated in FIG. 1). The drying apparatus may be configured to remove water and moisture from an object (e.g., hair, fabrics, body, hand) utilizing radiation from a radiation energy source assembly (e.g., the radiation energy source assembly 104) as a source of energy. The drying apparatus of the disclosure may be implemented as a fabric dryer, a hand dryer, a hair dryer, a body dryer, or any other dryers used in household, industry, agriculture, etc., as long as a radiation energy source assembly (e.g., one or more infrared lamps) is utilized as the source of energy. For example, a fabric dryer may utilize one or more infrared lamps as a heat source in association with an airflow generating element to facilitate evaporation of water from various fabrics such as clothes, bed sheets, curtains, plush toys, etc. In some embodiments, the drying apparatus may include an airflow generating assembly (e.g., the airflow generating assembly 103) configured to generate an airflow.

As shown in FIG. 2, the attachment 200 may include a radiation adjusting assembly 201, an airflow adjusting assembly 202, and a connecting assembly 203. In some embodiments, the attachment 200 may be configured to receive the radiation generated by the drying apparatus and output radiation by processing the received radiation. For example, the radiation adjusting assembly 201 may include a radiation inlet and a radiation outlet. At least a portion of the radiation (or referred to as first radiation) generated by a radiation energy source assembly (e.g., the radiation energy source assembly 104 illustrated in FIG. 1) of the drying apparatus may enter the attachment 200 through the radiation inlet of the radiation adjusting assembly 201. The first radiation may be processed by the radiation adjusting assembly 201 of the attachment 200 and second radiation may be output through the radiation outlet of the radiation adjusting assembly 201 of the attachment 200 (or referred to as the radiation outlet of the attachment 200 for brevity). In some embodiments, an area of the radiation outlet of the radiation adjusting assembly 201 may be the same as or different from an area of the radiation inlet of the radiation adjusting assembly 201. In some embodiments, a ratio of the area of the radiation outlet to the area of the radiation inlet may be in a range from 0.01-50, 0.02-40, 0.03-30, 0.05-20, 0.08-15, 0.1-10, etc. Merely by way of example, the ratio of the area of the radiation outlet to the area of the radiation inlet may be 1. That is, the area of the radiation outlet may be the same as the area of the radiation inlet.

The radiation adjusting assembly 201 may be configured to output the second radiation through the radiation outlet by processing the first radiation that enters the attachment 200 through the radiation inlet of the radiation adjusting assembly 201. In some embodiments, the radiation inlet of the radiation adjusting assembly 201 of the attachment 200 may (substantially) coincide with the radiation outlet 108 of the drying apparatus 100 as described in connection with FIG. 1. As used herein, substantially, when used to describe a feature (e.g., coinciding with, being the same as), may indicate that the deviation from the feature is below a threshold. For instance, that the radiation inlet of the radiation adjusting assembly 201 of the attachment 200 (substantially) coincides with the radiation outlet 108 of the drying apparatus 100 may indicate that the deviation of the radiation inlet of the radiation adjusting assembly 201 of the attachment 200 from the radiation outlet 108 of the drying apparatus 100 (e.g., assessed using a distance between a center of the radiation inlet of the radiation adjusting assembly 201 and a center of the radiation outlet 108 of the drying apparatus 100, an average deviation between a contour of the radiation inlet of the radiation adjusting assembly 201 and a contour of the radiation outlet 108 of the drying apparatus 100) is below a threshold (e.g., 5 millimeters, 3 millimeters, 2 millimeters, etc.).

In some embodiments, the radiation adjusting assembly 201 may process the first radiation by adjusting at least one radiation parameter of the first radiation. Exemplary radiation parameters of the first radiation may include a radiation energy density, a radiation path, a radiation field distribution, spectrum, or the like, or any combination thereof. As used herein, the radiation path refers to a path through which radiation travels in the attachment 200. The radiation field distribution may include a direction, a distribution (e.g., a radiation energy density distribution) of output radiation (e.g., the second radiation) exiting the radiation outlet, or a size (e.g., area) of each of at least one patch of the output radiation exiting the radiation outlet of the attachment 200. In some embodiments, the radiation adjusting assembly 201 may be configured to reduce the radiation energy density of the first radiation from the radiation inlet of the radiation adjusting assembly 201 of the attachment 200 (or referred to as the radiation inlet of the attachment 200 for brevity). In such cases, the second radiation may have a relatively lower radiation energy density at the radiation outlet of the attachment 200 than the first radiation, thereby decreasing a heating rate of the object irradiated by the second radiation. In some embodiments, the radiation adjusting assembly 201 may be configured to increase the radiation energy density of the first radiation such that the second radiation may have a relatively higher radiation energy density than the first radiation, thereby increasing a heating rate of the object irradiated by the second radiation. In some embodiments, the radiation adjusting assembly 201 may be configured to adjust the direction of the first radiation such that the distribution of output radiation (or referred to as second radiation) exiting the radiation outlet may be different from the distribution of the first radiation. In some embodiments, the radiation adjusting assembly 201 may be configured to adjust the size of each of at least one patch of the output radiation exiting the radiation outlet of the radiation adjusting assembly 201 of the attachment 200 (or referred to as the radiation output of the attachment 200 for brevity), for example, by configuring the radiation outlet of the attachment 200. For instance, the radiation outlet of the attachment 200 may be configured as a grille such that the output radiation exiting the radiation outlet may include a plurality of patches. As another example, the radiation outlet of the attachment 200 may be configured as a continuous opening such that the output radiation exiting the radiation outlet may include a single continuous patch. Merely by way of example, the size of each of the at least one patch of the output radiation may be adjusted by configuring one or more features of the at least one opening of the radiation output of the radiation adjusting assembly 201. Exemplary features of the at least one opening of the radiation output of the radiation adjusting assembly 201 may include an orientation, a size, a shape, a count of the at least one opening, or the like, or a combination thereof. In some embodiments, the radiation adjusting assembly 201 may be configured to adjust a degree of uniformity of the radiation. For instance, the radiation energy density of the first radiation may be unevenly distributed such that the radiation density of the first radiation is different at different positions of the radiation inlet of the radiation adjusting assembly 201 due to, e.g., locations of one or more radiation sources of the radiation energy source assembly. The radiation adjusting assembly 201 may be configured to adjust a degree of uniformity of the first radiation such that a degree of uniformity of the second radiation may be improved over the degree of uniformity of the first radiation.

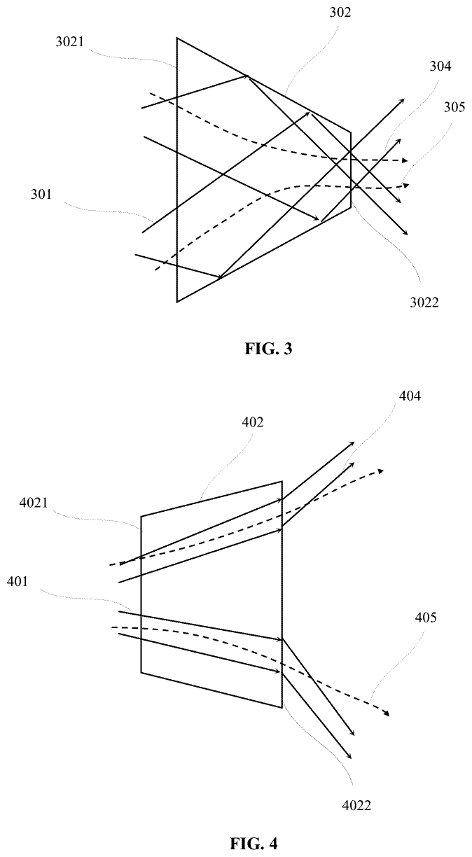

In some embodiments, the at least one radiation parameter of the first radiation may be adjusted by the radiation adjusting assembly 201 by a process including, e.g., reflection, refraction, absorption, transmission, diffraction, dispersion, waveguiding, etc. FIG. 3 is a schematic diagram illustrating an exemplary process for adjusting the at least one radiation parameter of the first radiation by an exemplary attachment 302 according to some embodiments of the present disclosure. As shown in FIG. 3, a direction of first radiation 301 that enters the attachment 302 through a radiation inlet 3021 of the attachment 302 may be adjusted by a process including reflection, refraction, transmission, diffraction, dispersion, waveguiding, etc. In such cases, at least one radiation parameter of the first radiation 301 may be adjusted. For example, the first radiation 301 may be converged along the axial direction of the attachment 302 toward a radiation outlet 3022 of the attachment 302 to form second radiation 304 output by the attachment 302 through the radiation outlet 3022. The second radiation 304 may have a higher radiation energy density than the first radiation 301. The radiation field distribution of the first radiation 301 may also be adjusted accordingly. For instance, the total area of the one or more patches of the second radiation exiting the radiation outlet of the attachment 302 may be decreased, compared to the total area through which the first radiation 301 enters the attachment 302 from the radiation inlet 3021 of the attachment 302. In some embodiments, the heating rate of the object irradiated by the second radiation 304 having a high radiation energy density may be increased, compared to the heating rate of the object irradiated by the first radiation 301. The attachment 302 may be used when an object needs to be quickly dried.

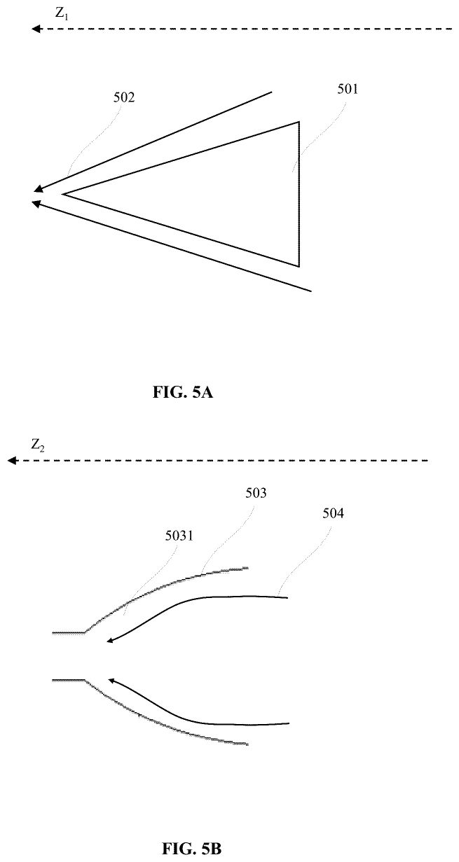

FIG. 4 is a schematic diagram illustrating an exemplary process for adjusting the at least one radiation parameter of the first radiation by an exemplary attachment 402 according to some embodiments of the present disclosure. As shown in FIG. 4, a direction of first radiation 401 that enters the attachment 402 through a radiation inlet 4021 of the attachment 402 may be adjusted by a process including reflection, refraction, transmission, diffraction, dispersion, waveguiding, etc. In such cases, at least one radiation parameter of the first radiation 401 may be adjusted. For example, the first radiation 401 may be diffused to form second radiation 404 output by the attachment 402 through the radiation outlet 4022. The second radiation 404 may have a lower radiation energy density than the first radiation 401. The radiation field distribution of the first radiation 401 may also be adjusted accordingly. For instance, the total area of the one or more patches of the second radiation 404 exiting the radiation outlet 4022 of the attachment 402 may be increased, compared to the total area through which the first radiation 401 enters the attachment 402 from the radiation inlet 4021 of the attachment 402. In some embodiments, the heating rate of the object irradiated by the second radiation 404 having a low radiation energy density may be reduced, compared to the heating rate of the object irradiated by the first radiation 401. The attachment 402 may be used when an object needs to be dried at a relatively low temperature. In some embodiments, the at least one radiation parameter of the first radiation may be adjusted by a process including, e.g., absorption. For example, at least a portion of the radiation adjusting assembly 201 may include a radiation-absorbing material such that at least a portion of the radiation that enters the attachment 200 may be absorbed by the at least a portion of the radiation adjusting assembly 201. In some embodiments, the absorbed radiation may be converted into heat energy. The heat energy may be used to heat an airflow that traverses the attachment 402. For instance, at least a portion of the heat energy may be consumed to increase the temperature of at least a portion of the attachment 402, which in turn may ultimately heat the airflow while the airflow traverses the attachment 402. Additionally or alternatively, at least a portion of the heat energy may directly heat the airflow while the airflow traverses the attachment 402.

In some embodiments, the radiation power of the first radiation that enters the attachment (e.g., the attachment 200, the attachment 302, the attachment 402) may be at least 5 watts (W), 10 W, 20 W, 30 W, 40 W, 50 W, 60 W, 70 W, 80 W, 90 W, 100 W, 110 W, 130 W, 150 W, 200 W, etc. In some embodiments, the first radiation may include radiation components in a wavelength range from 0.1 micrometers (μm) to 20 μm, 0.2 μm to 15 μm, 0.3 μm to 10 μm, 0.4 μm to 10 μm, etc. In some embodiments, the wavelength range of the second radiation may fall within the wavelength range of the first radiation. For example, the second radiation may include radiation components in a wavelength range that is substantially the same as that of the first radiation. For instance, that a second wavelength range is substantially the same as a first wavelength range may indicate that the deviation of the second wavelength range from the first wavelength range (e.g., assessed using a ratio of the non-overlapping portion between the first wavelength region and the second wavelength region to the overlapping portion between the first wavelength region and the second wavelength region) is below a threshold (e.g., 10%, 5%, etc.).

In some embodiments, at least a portion of the radiation adjusting assembly 201 may be located on a radiation path of the attachment 200. As used herein, at least a portion of a radiation adjusting assembly being located on a radiation path of the attachment may mean that radiation impinges on the at least a portion of the radiation adjusting assembly when traversing the attachment. For example, the radiation adjusting assembly 201 may face the radiation outlet 108 of the drying apparatus 100 that provides the first radiation as viewed in a cross-sectional view of the drying apparatus 100 (e.g., a radial cross-sectional view perpendicular to the axial direction Z₀ of the drying apparatus 100 illustrated in FIG. 1). As another example, a cross-sectional area of the at least a portion of the radiation adjusting assembly 201 (e.g., the radiation inlet of the radiation adjusting assembly 201) may be (substantially) the same as a cross-sectional area of the radiation outlet 108 of the drying apparatus 100. As a further example, a cross-sectional area of the at least a portion of the radiation adjusting assembly 201 (e.g., the radiation inlet of the radiation adjusting assembly 201) may be larger than a cross-sectional area of the radiation outlet 108 of the drying apparatus 100. That is, the radiation inlet of the radiation adjusting assembly 201 may cover the radiation outlet 108 of the drying apparatus 100 that provides the first radiation as viewed in the cross-sectional view of the drying apparatus 100. In some embodiments, radiation power of the first radiation may be at least 50%, 60%, 70%, 80%, 90%, 99.9%, etc., of the radiation power of the radiation generated by the radiation energy source assembly 104 of the drying apparatus 100. In some embodiments, the radiation power of the first radiation may be substantially 100% of the radiation power of the radiation generated by the radiation energy source assembly 104, meaning that substantially all the radiation generated by the radiation energy source assembly 104 can enter the attachment 200.

In some embodiments, at least a portion of the radiation adjusting assembly 201 may be arranged on a wall or surface located on the radiation path along which radiation travels within the attachment 200. In some embodiments, at least a portion of the radiation adjusting assembly may be configured by constructing the airflow adjusting assembly 202, the airflow guiding sub-assembly 2021, or a portion thereof, using a material with a desired radiation related property. In some embodiments, the radiation adjusting assembly 201 may be made of a material with a desired radiation related property to effectuate reflection, refraction, absorption, transmission, diffraction, dispersion, waveguiding, etc., of radiation. Exemplary radiation related properties may include radiation reflecting, radiation refracting, radiation absorbing, radiation transmitting, radiation diffracting, radiation dispersing, waveguiding, etc. In some embodiments, a desired radiation property of a material may be specific to a radiation component of a wavelength of a wavelength range. For instance, a material used to construct at least a portion of the attachment 200, e.g., a portion of the airflow adjusting assembly 202, may be radiation permeable to a radiation component whose wavelength is within a specific wavelength range (e.g., infrared radiation), and radiation reflecting with respect to one or more radiation components whose wavelengths are outside the specific wavelength range.

In some embodiments, the radiation adjusting assembly 201 may include a radiation-permeable material. As used herein, a material being radiation-permeable refers to that (substantially) all the radiation that impinges on the material can pass through the material. Merely by way of example, the radiation adjusting assembly 201 may be made of a material having a high infrared transmissivity such that (substantially) all the infrared radiation that impinges on the material can pass through the material. Exemplary materials for the radiation adjusting assembly 201 may include a silicate (e.g., sodium silicate), an oxide (e.g., silicon dioxide), a metal fluoride (e.g., a calcium fluoride, a barium fluoride), a metal sulfide, a metal selenide (e.g., a zinc sulfide, a zinc selenide), or a crystal (e.g., crystalline silicon, crystalline germanium).

In some embodiments, the radiation adjusting assembly 201 may include a radiation-reflecting material. Merely by way of example, the radiation adjusting assembly 201 may include a material with a radiation-reflecting property, such as a radiation-reflecting metal, a radiation-reflecting film, a radiation-reflecting coating, etc. As used herein, a material being radiation-reflecting refers to that (substantially) all the radiation that impinges on the material can be reflected by the material, and therefore not absorbed or pass through the material.

In some embodiments, the radiation adjusting assembly 201 may include a waveguiding material such as a fiber optic panel, an optical fiber, a fiber optic cable, etc. Merely by way of example, the radiation adjusting assembly 201 may include a waveguide arranged in the attachment 200. The waveguide may include a radiation inlet end and a radiation outlet end. At least a portion of the radiation inlet end may be located on a radiation path of attachment 200 such that at least a portion of the radiation entering the attachment 200 may be guided to the radiation outlet end. In some embodiments, at least one parameter of the waveguide including, e.g., a shape, a dimension, an orientation, etc., of the waveguide, may be configured such that at least a portion of the radiation may be guided to a desired position of an object.

In some embodiments, the radiation adjusting assembly 201 may include a radiation-refracting material or structural component such as a lens, a prism, etc. As used herein, a material or structural component being radiation-refracting indicates that (substantially) all the radiation that impinges on the material or structural component can be refracted (and substantially not absorbed) by the material or structural component.

In some embodiments, the radiation adjusting assembly 201 may include a radiation-absorbing material or structural component. As used herein, a material or structural component being radiation-absorbing indicates that (substantially) all the radiation that impinges on the material can be absorbed by the material or structural component. In some embodiments, the absorbed radiation may be converted into heat energy. The heat energy may be used to heat an airflow that traverses the attachment 200.

In some embodiments, the radiation adjusting assembly 201 may include a radiation-diffracting material or structural component such as a grating. As used herein, a material or structural component being radiation-diffracting indicates that (substantially) all the radiation that impinges on the material can be diffracted (and substantially not absorbed) by the material.

In some embodiments, the radiation adjusting assembly 201 may include a radiation-dispersing material or structural component. As used herein, a material or structural component being radiation-dispersing refers to that (substantially) all the radiation that impinges on the material can be dispersed (and substantially not absorbed) by the material.

The airflow adjusting assembly 202 may provide an airflow path having an airflow inlet and an airflow outlet. An airflow generated by the airflow generating assembly of the drying apparatus may enter the attachment 200 through the airflow inlet of the airflow path and exit the attachment 200 through the airflow outlet of the airflow path. In some embodiments, the airflow adjusting assembly 202 may be configured to adjust the airflow. In some embodiments, at least a portion of the attachment 200 may be configured as the airflow adjusting assembly 202. For example, the airflow path may be formed by an inner wall of the attachment 200. In some embodiments, at least a portion of the radiation adjusting assembly 201 may be configured on or as at least a portion of the airflow adjusting assembly 202. For example, the radiation adjusting assembly 201 may be configured by coating at least a portion of the airflow path with a material of a desired radiation related property.

In some embodiments, the airflow outlet may be configured as a grille. The grille may include a plurality of openings. At least a portion of the airflow may be blocked or interfered by the grille before exiting the attachment 200 through the plurality of openings. In such cases, the airflow may be dispersed by the grille and the velocity of the airflow may decrease.

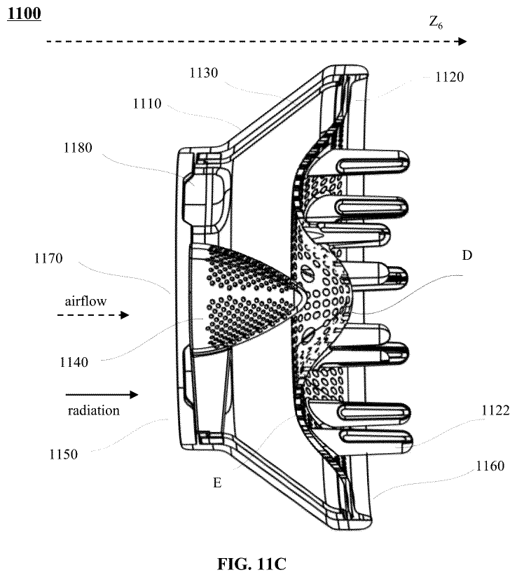

In some embodiments, the airflow path and/or the airflow adjusting assembly 202 may be configured to adjust at least one first airflow parameter of the airflow that enters the attachment 200 via the airflow inlet of the attachment 200. For example, the airflow adjusting assembly 202 may be configured such that the airflow path may be adjusted. Correspondingly, at least one first airflow parameter of the airflow may be adjusted. Exemplary first airflow parameters may include a flow rate, a velocity, a direction of the airflow at the airflow outlet, temperature, humidity, a composition of the airflow, etc. In some embodiments, cross sections of the airflow path may be configured to adjust the at least one first airflow parameter of the airflow. For instance, the airflow path may narrow gradually from the airflow inlet to the airflow outlet of the airflow path of the attachment 200. In such cases, the airflow entering the attachment 200 from the airflow inlet of the attachment 200 may be converged and then exit the attachment 200 through the airflow outlet (e.g., the airflow 305 in dotted lines in FIG. 3). Accordingly, the velocity of the airflow may be increased. As another example, the airflow path may expand gradually from the airflow inlet to the airflow outlet of the airflow path. In such cases, the airflow entering the attachment 200 from the airflow inlet may be diffused and then exit the attachment 200 through the airflow outlet (e.g., the airflow 405 in dotted lines in FIG. 4). Accordingly, the velocity of the airflow may be decreased. In some embodiments, the airflow adjusting assembly 202 may include a component with openings facing different directions (e.g., a radiation-permeable cover 1120 including a plurality of columns 1122 illustrated in FIG. 11). In such cases, the direction of the airflow at the airflow outlet of the attachment 200 may be adjusted by the configuration of the openings of the component. In some embodiments, the airflow adjusting assembly 202 may include a heating component (e.g., a resistive wire grid) disposed in the attachment 200 (e.g., the airflow path provided by the airflow adjusting assembly 202 or the attachment 200). The heating component may be configured to heat the airflow and/or dehumidify the airflow. In some embodiments, the airflow adjusting assembly 202 may include a negative ion generator disposed in the attachment 200. The negative ion generator may be configured to generate negative ions such that the composition of the airflow may be adjusted.

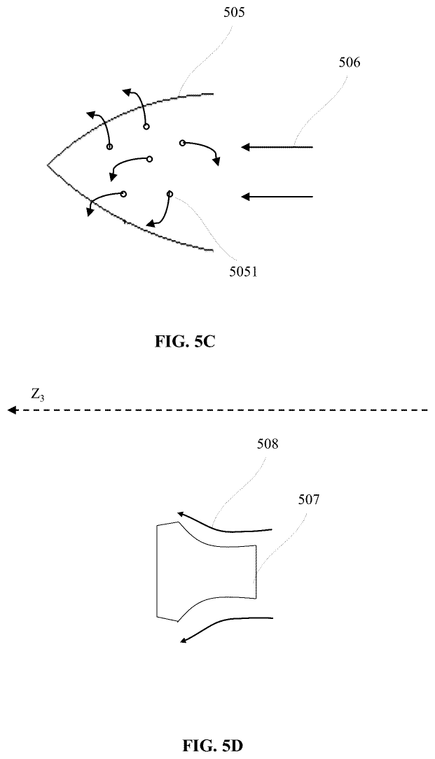

In some embodiments, the airflow adjusting assembly 202 may include at least one additional adjusting component. For example, the at least one additional adjusting component may include an airflow guiding sub-assembly 2021. The airflow guiding sub-assembly 2021 may be arranged in the airflow path. For example, the airflow guiding sub-assembly 2021 may be arranged at a position in the airflow path that faces the airflow outlet of the airflow generating assembly of the dry apparatus. In some embodiments, the airflow guiding sub-assembly 2021 may be connected to a portion of the attachment 200 (e.g., the inner wall of the attachment 200) through one or more connecting parts. For example, two ends of each of the connecting parts may physically connect the airflow guiding sub-assembly 2021 to a portion of the attachment 200, respectively. In some embodiments, the airflow guiding sub-assembly 2021 may be configured to adjust at least one second airflow parameter of the airflow. Exemplary second airflow parameters may include a velocity, a direction, temperature, humidity, a composition, etc., of the airflow. See, e.g., FIGS. 5A-5D that provide schematic diagrams illustrating exemplary airflow guiding sub-assemblies according to some embodiments of the present disclosure.

As shown in FIG. 5A, the exemplary airflow guiding sub-assembly may include a guiding wall 501 having a tapered shape as viewed in a radial cross-sectional view (e.g., a radial cross-sectional view perpendicular to the axial direction Z₁ pointing from the airflow inlet to the airflow outlet as shown in FIG. 5A). Accordingly, the velocity of the airflow 502 may be adjusted (e.g., increased). The guiding wall 501 may be configured to guide an airflow 502 that moves along the guiding wall 501 such that the direction of the airflow 502 may be adjusted.

As shown in FIG. 5B, the exemplary airflow guiding sub-assembly may include a guiding surface 503 that narrows gradually in a direction from the airflow inlet to the airflow outlet of the airflow path (e.g., a direction parallel to axial direction Z₂ pointing from the airflow inlet to the airflow outlet as shown in FIG. 5B). The guiding surface 503 may include an airflow channel 5031 through which at least a portion of the airflow 504 traverses. Cross sections of the airflow channel 5031 may be configured to adjust the at least one second airflow parameter of the at least a portion of the airflow. For example, with the guiding surface 503 narrowing gradually, areas of the cross sections of the airflow channel 5031 may decrease gradually. Accordingly, the velocity of the airflow 504 may be adjusted (e.g., increased). The direction of the airflow 504 may be also adjusted (e.g., the airflow 504 being converged).

As shown in FIG. 5C, the exemplary airflow guiding sub-assembly may include a grille 505 including a plurality of openings 5051. The airflow 506 may be blocked or interfered by the grille 505 before exiting the grille 505 through the plurality of openings 5051. In such cases, the velocity of the airflow 506 may be adjusted (e.g., decreased and/or increased). In addition, the airflow 506 may exit the grille 505 through the plurality of openings 5051 in a plurality of directions.

As shown in FIG. 5D, the exemplary airflow guiding sub-assembly may include a guiding column 507. The guiding column 507 may include a surface expanding gradually in a direction from the airflow inlet to the airflow outlet (e.g., a direction parallel to axial direction Z₃ as shown in FIG. 5D). The airflow 508 may be blocked or interfered by the surface of the guiding column 507. Accordingly, the velocity of the airflow 508 may be adjusted (e.g., decreased). The airflow 508 may move along the surface of the guiding column 507 such that the direction of the airflow 508 may be adjusted.

In some embodiments, at least a portion of the airflow guiding sub-assembly 2021 may be configured to function as the radiation adjusting assembly 201. In some embodiments, at least a portion of the radiation adjusting assembly 201 may be arranged on a wall or surface of the airflow guiding sub-assembly 2021. Merely by way of example, the at least a portion of the radiation adjusting assembly 201 may include a radiation-reflecting material coated on the surface of the airflow guiding sub-assembly 2021 such that radiation may be reflected by the radiation-reflecting material of the airflow guiding sub-assembly 2021. As another example, the at least a portion of the radiation adjusting assembly 201 may include a radiation-absorbing material coated on the surface of the airflow guiding sub-assembly 2021 such that radiation impinging thereon may be absorbed by the radiation-absorbed material. In some embodiments, the absorbed radiation may be converted into heat energy. The heat energy may be used to heat the airflow that traverses the attachment 200. In some embodiments, at least a portion of the airflow guiding sub-assembly 2021 may be configured using a material with a desired radiation related property so as to function as the radiation adjusting assembly 201. Merely by way of example, at least a portion of the airflow guiding sub-assembly 2021 or the whole airflow guiding sub-assembly 2021 may be made of a radiation-permeable material such that at least a portion of the radiation impinging thereon may traverse the airflow guiding sub-assembly 2021.

The connecting assembly 203 may be configured to operably connect the attachment 200 to the drying apparatus 100. For example, the attachment 200 may be removably attached to a component (e.g., the housing 101, the airflow channel 102, or the radiation energy source assembly 104 as described in FIG. 1) of the drying apparatus 100 by the connecting assembly 203. Through the operable connection between the attachment 200 and the drying apparatus 100, at least a portion of the radiation and/or airflow generated by the drying apparatus 100 may enter the attachment 200.

In some embodiments, the attachment 200 may be removably attached to the drying apparatus 100 through a threaded connection, a buckle connection, a magnetic connection, a friction type connection, etc. For example, the connecting assembly 203 of the attachment 200 may include a thread portion that is complimentary to the connecting assembly 107 of the drying apparatus 100 including a thread portion such that the attachment 200 may be removably attached to the drying apparatus 100 via the threaded connection. As another example, the connecting assembly 203 of the attachment 200 may include a buckle that is configured to be held by the connecting assembly 107 of the drying apparatus 100 including a catch such that the attachment 200 may be removably attached to the drying apparatus 100 through the buckle connection. As a further example, the connecting assembly 203 of the attachment 200 may include a magnet that attracts the connecting assembly 107 of the drying apparatus 100 including a ferromagnetic material or a magnet such that the attachment 200 may be removably attached to the drying apparatus 100 through the magnetic connection. As still a further example, the connecting assembly 203 of the attachment 200 may include a ferromagnetic material that is attracted by the connecting assembly 107 of the drying apparatus 100 including a magnet such that the attachment may be removably attached to the drying apparatus 100 through the magnetic connection. As still a further example, the connecting assembly 203 of the attachment 200 and the connecting assembly 206 of the drying apparatus 100 may be snugly fit together by friction such that the attachment may be removably attached to the drying apparatus 100 through the friction type connection.

It should be noted that the above description is merely provided for the purposes of illustration, and not intended to limit the scope of the present disclosure. For persons having ordinary skills in the art, multiple variations and modifications may be made under the teaching of the present invention. However, those variations and modifications do not depart from the scope of the present disclosure. For example, the airflow guiding sub-assembly 2021 may be omitted. As another example, at least two of the assemblies illustrated in the attachment 200 may be combined in one or more embodiments.

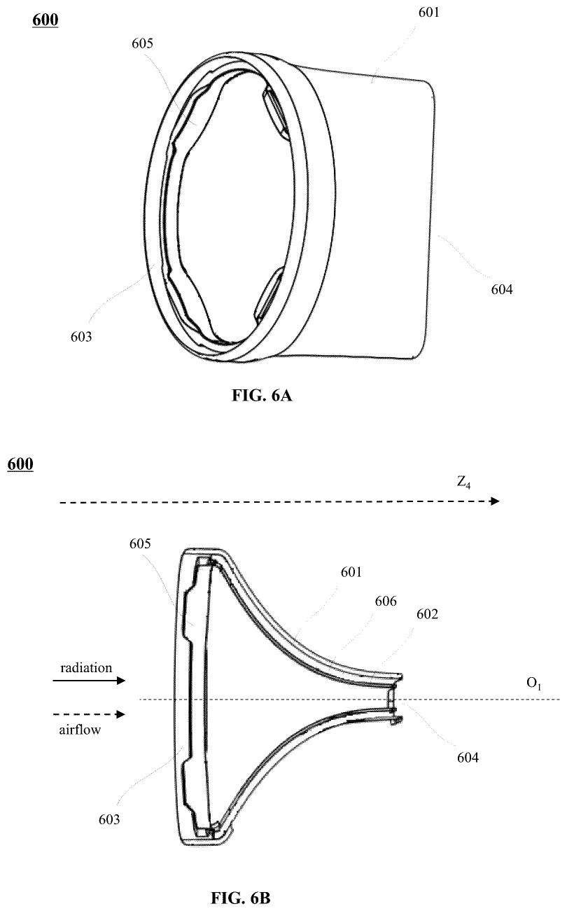

FIGS. 6A and 6B provide views of an exemplary attachment 600 according to some embodiments of the present disclosure. In some embodiments, the attachment 600 may be an exemplary embodiment of the attachment 200 described in FIG. 2. As shown in FIGS. 6A and 6B, the attachment 600 may include a housing 601, an airflow adjusting assembly 602, an airflow inlet 603, an airflow outlet 604, and a connecting assembly 605.

An airflow (e.g., at least a portion of the airflow generated by the drying apparatus 100 illustrated in FIG. 1) may enter the attachment 600 through the airflow inlet 603. In some embodiments, the airflow inlet 603 of the attachment 600 may be configured based on the airflow outlet 1022 of the drying apparatus 100. For instance, the airflow inlet 603 of the attachment 600 may be configured such that it (substantially) coincides with the airflow outlet 1022 of the drying apparatus 100 to allow (substantially) all the airflow exiting the airflow outlet 1022 of the drying apparatus 100 to enter the attachment 600 through the airflow inlet 603. For example, an orientation, a shape, a position, a cross-sectional area (a cross-sectional area viewed in an axial direction Z₄ of the attachment 600 illustrated in FIG. 6B) of the airflow inlet 603 of the attachment 600 may be configured based on the airflow outlet 1022 of the drying apparatus 100 such that the airflow inlet 603 of the attachment 600 and the airflow outlet 1022 of the drying apparatus 100 may (substantially) coincide to allow (substantially) all the airflow exiting the airflow outlet 1022 of the drying apparatus 100 to enter the attachment 600 through the airflow inlet 603. In some embodiments, at least a portion of the airflow may exit the attachment 600 through the airflow outlet 604.

Radiation (e.g., at least a portion of the radiation generated by the drying apparatus 100 illustrated in FIG. 1) may enter the attachment 600 through a radiation inlet (or referred to as first radiation). In some embodiments, the airflow inlet 603 and the radiation inlet of the attachment 600 may at least partially overlap. For instance, the airflow inlet 603 may be (substantially) coextensive with the radiation inlet of the attachment 600; in other words, the airflow inlet 603 may also function as the radiation inlet.

In some embodiments, at least a portion of the radiation may exit the attachment 600 through a radiation outlet (or referred to as second radiation). The airflow outlet 604 and the radiation outlet may at least partially overlap. For instance, the airflow outlet 604 may be (substantially) coextensive with the radiation outlet of the attachment 600; in other words, the airflow outlet 604 may also function as a radiation outlet.

The housing 601 may enclose one or more components (e.g., the airflow adjusting assembly 602) of the attachment 600. As shown in FIGS. 6A and 6B, the housing 601 may narrow gradually in a direction from the airflow inlet 603 to the airflow outlet 604.

In some embodiments, the attachment 600 may provide an airflow path along which an airflow may travel in the attachment 600. At least a portion of the airflow path may be defined by the airflow adjusting assembly 602 (e.g., the inner wall of the airflow adjusting assembly 602). The airflow entering the attachment 600 through the airflow inlet 603 may traverse the attachment 600 along the airflow path. In some embodiments, the airflow adjusting assembly 602 may be configured to adjust at least one first airflow parameter of the airflow that enters the attachment 600. Exemplary first airflow parameters of the airflow may include a flow rate, a velocity, a direction of the airflow at the airflow outlet 604, temperature, humidity, a composition of the airflow, etc. For example, with the airflow path narrowing gradually from the airflow inlet 603 to the airflow outlet 604 of the airflow path of the attachment 600, the airflow entering the attachment 600 from the airflow inlet 603 of the attachment 600 may be converged and then exit the attachment 600 through the airflow outlet 604. Accordingly, the velocity of the airflow at the airflow outlet 604 of the attachment 600 may be increased, compared to the velocity of the airflow at the airflow inlet 603 of the attachment 600.

The airflow adjusting assembly 602 may be arranged inside the housing 601. For example, the airflow adjusting assembly 602 may be physically attached to the housing 601 at or in the vicinity of the airflow inlet 603. As shown in FIGS. 6A and 6B, an outer wall (or surface) of the airflow adjusting assembly 602 may be substantially parallel to an inner wall (or surface) of the housing 601. As used herein, an inner wall or surface of a structure (e.g., the airflow adjusting assembly 602, the housing 601) refers to a wall or surface of the structure that is closer to a central axis of the structure (e.g., an axis O₁ of the airflow adjusting assembly 602 or the housing 601) than an outer wall or surface of the structure, or faces the interior of a space enclosed or defined by the structure (e.g., the airflow path of the attachment 600). As used herein, an outer wall or surface of a structure refers to a wall or surface of the structure that is farther away from a central axis of the structure (e.g., the axis O₁ of the airflow adjusting assembly 602 or the housing 601) than an inner wall or surface of the structure, or faces the exterior of a space enclosed or defined by the structure (e.g., the airflow path of the attachment 600). For example, a deviation of each of distances between the outer wall of the airflow adjusting assembly 602 and the inner wall of the housing 601 at different locations, from a reference distance (e.g., the maximum distance of the distances, the minimum distance of the distances, an average of the distances), may be below a threshold (e.g., 0.01 millimeters (mm), 0.02 mm, 0.04 mm, 0.06 mm, 0.1 mm, etc.). In some embodiments, a distance between the outer wall of the airflow adjusting assembly 602 and the inner wall of the housing 601 may be in a range from 0.5 mm to 5 mm. In some embodiments, at least a portion of radiation that impinges on at least portion of the airflow adjusting assembly 602, or a material with a radiation related property attached on at least a portion of the airflow adjusting assembly 602, may be absorbed by the airflow adjusting assembly 602. The absorbed radiation may be converted into heat energy. A temperature of the airflow adjusting assembly 602 may increase accordingly. A space 606 between the outer wall of the airflow adjusting assembly 602 and the inner wall of the housing 601 may separate the airflow adjusting assembly 602 from the housing 601, thereby preventing or reducing the temperature increase in the housing 601, which in turn may reduce the risk that a user is burned when touching the housing 601. In some embodiments, the space 606 may also provide an additional airflow path. The additional airflow path may include an opening at or in the vicinity of the airflow inlet 603 of the attachment 600 and an opening at the airflow outlet 604 of the attachment 600. An airflow (e.g., from the environment, from the airflow exiting the drying apparatus 100, or the like, or a combination thereof) entering the additional airflow path through the opening may absorb and carry away at least a portion of the heat energy generated in the airflow adjusting assembly 602, which may reduce the temperature change of the airflow adjusting assembly 602 and/or the temperature change of the housing 601 due to the heat energy, thereby further reducing the risk that the user is burned when touching the housing 601.

In some embodiments, the attachment 600 may include a radiation adjusting assembly (not shown). The radiation adjusting assembly may be configured to adjust at least one radiation parameter of the first radiation entering the attachment 600 such that second radiation may be output by the attachment 600 through the airflow outlet 604. As described in connection with FIG. 2, exemplary radiation parameters of the first radiation may include a radiation energy density, a radiation path, a radiation field distribution, spectrum, etc. In some embodiments, at least a portion of the first radiation may be consumed to heat the airflow. The at least one radiation parameter of the first radiation may be adjusted accordingly. In some embodiments, the at least a portion of the first radiation may be consumed to heat the airflow by a process including at least one of reflection or absorption. For example, at least a portion of the radiation adjusting assembly may include a radiation-absorbing material. At least a portion of the first radiation impinging on the radiation adjusting assembly may be absorbed or reflected to heat the airflow. Merely by way of example, at least 50%, 60%, 70%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5%, 99.6%, 99.7%, 99.8%, 99.9%, etc., of the radiation impinging on the radiation adjusting assembly may be consumed by the process including reflection or absorption. In some embodiments, the radiation adjusting assembly may be configured such that (substantially) all radiation that impinges on the radiation adjusting assembly is absorbed. In some embodiments, the absorbed radiation may be converted into heat energy and therefore a temperature of the radiation adjusting assembly, and/or the temperature of the airflow adjusting assembly 602, or a portion thereof may increase. The heat energy may be ultimately transferred from the radiation adjusting assembly to the airflow such that a temperature of the airflow may increase accordingly. In some embodiments, at least a portion of the radiation may heat the airflow directly.

In some embodiments, at least a portion of the radiation adjusting assembly may be arranged on a wall or surface located on a radiation path along which radiation travels within the attachment 600. For instance, at least a portion of the radiation adjusting assembly may be arranged on an inner surface of the airflow path defined by the airflow adjusting assembly 602. In some embodiments, at least a portion of the radiation adjusting assembly may be configured by constructing the airflow adjusting assembly 602, or a portion thereof, using a material with a desired radiation related property. Exemplary radiation related properties may include radiation reflecting, radiation absorbing, etc.

In some embodiments, the radiation adjusting assembly may be a coating applied on the inner wall of the airflow adjusting assembly 602. As another example, the radiation adjusting assembly may include a film attached to the inner wall of the airflow adjusting assembly 602. In some embodiments, the radiation adjusting assembly that is arranged on the inner surface of the airflow path defined by the airflow adjusting assembly 602 may be located on a radiation path of the attachment 600 such that radiation impinges on the radiation adjusting assembly when traversing the attachment 600. The radiation adjusting assembly arranged on the airflow adjusting assembly 602 may face the radiation outlet 108 of the drying apparatus 100 to receive at least a portion of the radiation generated by the drying apparatus 100. For example, a cross-sectional area of the at least a portion of the airflow adjusting assembly 602 with the radiation adjusting assembly arranged thereon may be (substantially) the same as or larger than a cross-sectional area of the radiation outlet 108 of the drying apparatus 100. In some embodiments, the radiation power of the first radiation at the radiation inlet may be at least 50%, 60%, 70%, 80%, 90%, 99.9%, etc., of the radiation power of the radiation generated by the radiation energy source assembly 104 of the drying apparatus 100. In some instances, the radiation power of the first radiation may be substantially 100% of the radiation power of the radiation generated by the radiation energy source assembly 104, meaning that substantially all the radiation generated by the radiation energy source assembly 104 can enter the attachment 600.

The connecting assembly 605 may be configured to operably connect the attachment 600 to the drying apparatus 100. For example, the attachment 600 may be removably attached, by the connecting assembly 605, to a component (e.g., the housing 101 or the wall 1024 as described in FIG. 1) of the drying apparatus 100. Through the operable connection between the attachment 600 and the drying apparatus 100, at least a portion of the radiation and/or airflow generated by the drying apparatus 100 enters the attachment 600.

In some embodiments, as described in connection with FIG. 2, the attachment 600 may be removably attached to the drying apparatus 100 through a threaded connection, a buckle connection, a magnetic connection, a friction type connection, etc. For example, as shown in FIGS. 6A and 6B, the connecting assembly 605 of the attachment 600 may include a magnet that attracts the connecting assembly 107 of the drying apparatus 100 including a ferromagnetic material or a magnet such that the attachment 600 may be removably attached to the drying apparatus 100 through the magnetic connection. As another example, the connecting assembly 605 of the attachment 600 may include a ferromagnetic material that is attracted by the connecting assembly 107 of the drying apparatus 100 including a magnet such that the attachment 600 may be removably attached to the drying apparatus 100 through the magnetic connection.

With the attachment 600 illustrated in FIGS. 6A and 6B, the airflow that enters the attachment 600 through the airflow inlet 603 of the attachment 600 may be converged along the axial direction Z₄ toward the airflow outlet 604 when traversing the airflow path that narrows gradually along the axial direction Z₄ toward the airflow outlet 604. In such cases, an airflow with an increased velocity may be output by the attachment 600. At least a portion of the first radiation that enters the attachment 600 through the radiation inlet may be consumed to heat the airflow traversing the attachment 600 such that an airflow with an increased temperature may be output by the attachment 600. In addition, the radiation parameter may be adjusted accordingly. The second radiation with the adjusted radiation parameter may be output by the attachment 600 through the radiation outlet. In some embodiments, the second radiation may have a lower radiation energy density than the first radiation due to, e.g., the radiation energy consumed to directly or ultimately heat the airflow. For example, a ratio of a radiation energy density of the second radiation to a radiation energy density of the first radiation may be less than 1, 0.9, 0.8, 0.7, 0.6, 0.5, 0.4, 0.3, 0.2, 0.1, etc. Merely by way of example, the radiation energy density of the radiation provided by the drying apparatus 100 without the attachment 600 at a same position as the radiation outlet of the attachment 600 may be from 5 kW/m² to 100 kW/m². And the radiation energy density of the second radiation at the radiation outlet of the attachment 600 may be from 0.01 kW/m² to 20 kW/m². The radiation field distribution of the first radiation may also be adjusted. For example, a total area of one or more patches of the second radiation exiting the radiation outlet of the attachment 600 may be decreased, compared to a total area through which the first radiation enters the attachment 600 from the radiation inlet of the attachment 600. With the radiation adjusting assembly (e.g., the portion of the radiation adjusting assembly arranged on the inner wall of the airflow adjusting assembly 602), a significant portion of the radiation power of the first radiation may be consumed to directly or ultimately heat the airflow in the attachment 600. In some embodiments, a ratio of the radiation power of the second radiation to the radiation power of the first radiation may be less than 1, 0.9, 0.8, 0.7, 0.6, 0.5, 0.4, 0.3, 0.2, etc. For example, the radiation power of the first radiation may be 100 W, and the radiation power of the second radiation may be less than 20 W.

It should be noted that the above description is merely provided for the purposes of illustration, and not intended to limit the scope of the present disclosure. For persons having ordinary skills in the art, multiple variations and modifications may be made under the teaching of the present invention. However, those variations and modifications do not depart from the scope of the present disclosure. For example, one or more components (e.g., the space 606) of the attachment 650 may be omitted. As another example, an airflow guiding sub-assembly (e.g., the airflow guiding sub-assembly 2021, the airflow guiding sub-assembly in FIG. 5A, the airflow guiding sub-assembly in FIG. 5B, etc.) may be arranged in the housing 601.

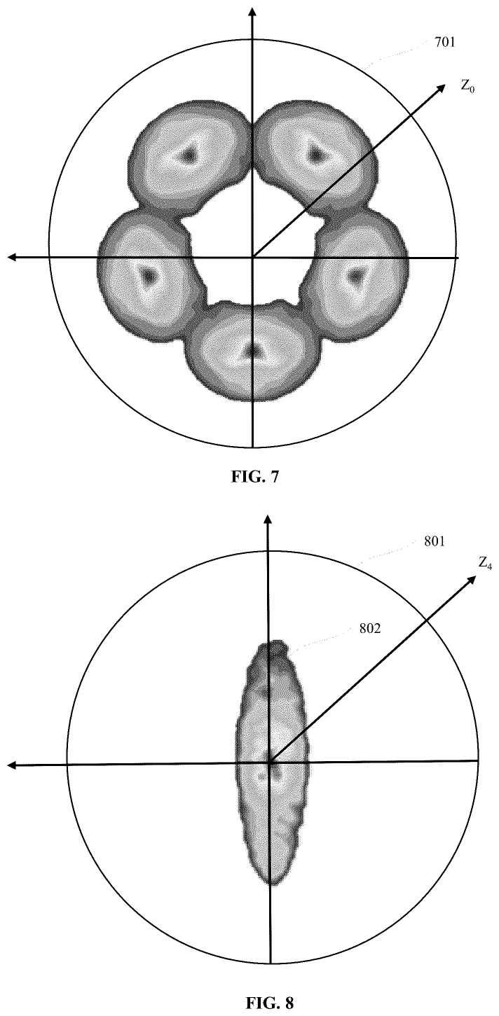

FIG. 7 provides a radial view of a radiation energy density distribution of radiation generated by the radiation energy source assembly 104 of the dry apparatus 100 according to some embodiments of the present disclosure. The radial view may be perpendicular to an axis of the airflow channel 102 of the drying apparatus 100 denoted by Z₀ (pointing into the paper as illustrated in FIG. 7, the same as Z₀ illustrated in FIG. 1). The radiation energy density distribution was obtained at the radiation outlet 108 of the drying apparatus 100. The radiation energy density distribution was shown in a region 701. The radiation energy density distribution may depend on a distribution of the one or more radiation energy sources of the radiation energy source assembly 104. Each patch 702 illustrated in FIG. 7A may correspond to a radiation energy source of the radiation energy source assembly 104. A radiation energy density in a center region (denoted by the dashed circle A) is higher than a radiation energy density in a peripheral region B (as indicated by the dashed circle in FIG. 7) of the radiation energy source of the radiation energy source assembly 104. In some embodiments, the first radiation at the radiation inlet of the attachment 600 may be substantially the same as the radiation energy density distribution at the radiation outlet 108 of the drying apparatus 100.

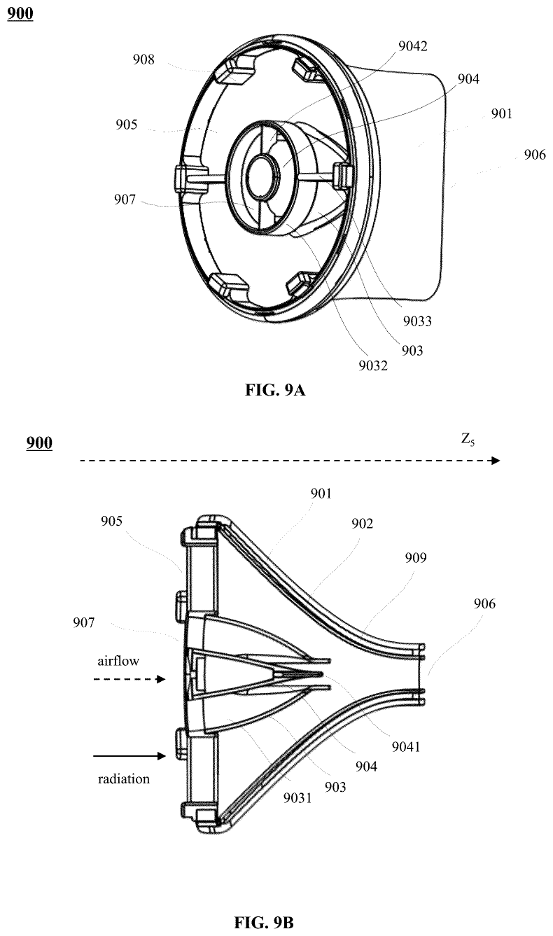

FIG. 8 provides a radial view of a radiation energy density distribution of the second radiation at the radiation outlet of the attachment 600 illustrated in FIGS. 6A and 6B according to some embodiments of the present disclosure. The radial view may be perpendicular to the axial direction Z₄ of the attachment 600 illustrated in FIG. 6B (pointing into the paper as illustrated in FIG. 8). An area of a region 801 in which the radiation energy density distribution was shown in FIG. 8 was the same as an area of a region 701 in which the radiation energy density distribution was shown in FIG. 7. As shown in FIG. 8, the second radiation exiting the radiation outlet of the attachment 600 may include a patch 802 located in a center region of the region 801. A total area of the patch 802 may be decreased, compared to a total area of the one or more patches 702 of the radiation at the radiation outlet 108 of the drying apparatus 100. The radiation energy density of the second radiation weakened gradually from a center of the patch 802 outward. In addition, the radiation energy density in the patch 802 of the second radiation is lower than the radiation energy density in each patch 702 as illustrated in FIG. 7. That is, a significant portion of the first radiation that entered the attachment 600 was consumed in the attachment 600 and a relatively small amount of second radiation was output by the attachment 600.

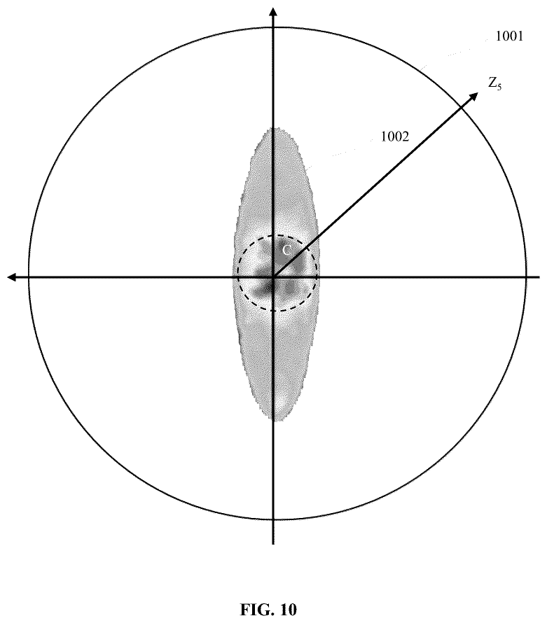

FIGS. 9A and 9B provide views of an exemplary attachment 900 according to some embodiments of the present disclosure. In some embodiments, the attachment 900 may be an exemplary embodiment of the attachment 200 described in FIG. 2. As shown in FIGS. 9A and 9B, the attachment 900 may include a housing 901, an airflow adjusting assembly 902, a guiding surface 903, a guiding wall 904, a radiation inlet 905, a radiation outlet 906, an airflow inlet 907, and a connecting assembly 908, etc.

Radiation (e.g., at least a portion of the radiation generated by the drying apparatus 100 illustrated in FIG. 1) may enter the attachment 900 through the radiation inlet 905 (or referred to as first radiation). An airflow (e.g., at least a portion of the airflow generated by the drying apparatus 100 illustrated in FIG. 1) may enter the attachment 900 through the airflow inlet 907 and at least a portion of the airflow may exit the attachment 900 through the radiation outlet 906.

The radiation inlet 905 may be arranged around the airflow inlet 907. In some embodiments, the radiation inlet 905 of the attachment 900 may be configured based on the radiation outlet 108 of the drying apparatus 100 such that the radiation inlet 905 of the attachment 900 and the radiation outlet 108 of the drying apparatus 100 may (substantially) coincide to allow (substantially) all radiation exiting the radiation outlet 108 of the drying apparatus 100 to enter the attachment 900 through the radiation inlet 905. For example, an orientation, a shape, a position, a cross-sectional area (a cross-sectional area viewed in an axial direction Z₅ of the attachment 900 illustrated in FIG. 9B) of the radiation inlet 905 of the attachment 900 may be configured based on the radiation outlet 108 of the drying apparatus 100 such that the radiation inlet 905 of the attachment 900 and the radiation outlet 108 of the drying apparatus 100 may substantially coincide to allow (substantially) all radiation exiting the radiation outlet 108 of the drying apparatus 100 to enter the attachment 900 through the radiation inlet 905. In some embodiments, the airflow inlet 907 of the attachment 900 may be configured based on the airflow outlet 1022 of the drying apparatus 100 such that the airflow inlet 907 of the attachment 900 and the airflow outlet 1022 of the drying apparatus 100 may (substantially) coincide to allow (substantially) all airflow exiting the airflow outlet 1022 of the drying apparatus 100 to enter the attachment 900 through the airflow inlet 907.

In some embodiments, at least a portion of radiation may exit the attachment 900 through the radiation outlet 906 (or referred to as second radiation). In some embodiments, the radiation outlet 906 and the airflow outlet of the attachment 900 may at least partially overlap. For instance, the radiation outlet 906 may be (substantially) coextensive with the airflow outlet of the attachment 900; in other words, the radiation outlet 906 may also function as an airflow outlet.

The housing 901 may enclose one or more components (e.g., the airflow adjusting assembly 902, the guiding surface 903, the guiding wall 904) of the attachment 900. As shown in FIGS. 9A and 9B, the housing 901 may narrow gradually in a direction from the radiation inlet 905 to the radiation outlet 906.

In some embodiments, the attachment 900 may provide an airflow path along which an airflow in the attachment 900 may travel. At least a portion of the airflow path may be defined by the airflow adjusting assembly 902 (e.g., the inner wall of the airflow adjusting assembly 902). The airflow entering the attachment 900 through the airflow inlet 907 may traverse the attachment 900 along the airflow path. The guiding surface 903 and the guiding wall 904 may be arranged in the airflow path of the attachment 900. In some embodiments, the airflow adjusting assembly 902, the guiding surface 903, and the guiding wall 904, may be configured to adjust at least one airflow parameter of the airflow that traverses the attachment 900. Exemplary airflow parameters of the airflow may include a flow rate, a velocity, a direction of the airflow at the airflow outlet, temperature, humidity, a composition of the airflow, etc.

The airflow adjusting assembly 902 may be arranged inside the housing 901. For example, the airflow adjusting assembly 902 may be physically attached to the housing 901 at or in the vicinity of the airflow inlet. As shown in FIGS. 9A and 9B, an outer wall (or surface) of the airflow adjusting assembly 902 may be substantially parallel to an inner wall (or surface) of the housing 901. For example, a deviation of each of distances between the outer wall of the airflow adjusting assembly 902 and the inner wall of the housing 901 at different locations, from a reference distance (e.g., the maximum distance of the distances, the minimum distance of the distances, an average of the distances), may be below a threshold (e.g., 0.01 millimeters (mm), 0.02 mm, 0.04 mm, 0.06 mm, 0.1 mm, etc.). In some embodiments, a distance between the outer wall of the airflow adjusting assembly 902 and the inner wall of the housing 901 may be in a range from 0.5 mm to 5 mm. In some embodiments, at least a portion of radiation that impinges on the airflow adjusting assembly 902 may be absorbed by the airflow adjusting assembly 902. The absorbed radiation may be converted into heat energy. A temperature of the airflow adjusting assembly 902 may increase accordingly. A space 909 between the outer wall of the airflow adjusting assembly 902 and the inner wall of the housing 901 may separate the airflow adjusting assembly 902 from the housing 901, thereby preventing or reducing the temperature increase in the housing 901, which in turn may reduce the risk that a user is burned when touching the housing 901. In some embodiments, the space 909 may also function as an additional airflow path. The additional airflow path may include an opening at or in the vicinity of the radiation inlet 905 or the airflow inlet 907 of the attachment 900 and an opening at the radiation outlet 906 of the attachment 900. An airflow (e.g., from the environment, from the airflow exiting the drying apparatus 100, or the like, or a combination thereof) entering the additional airflow path through the opening may absorb and carry away at least a portion of the heat energy generated in the airflow adjusting assembly 902, which may reduce the temperature of the airflow adjusting assembly 902, thereby further reducing the risk that the user is burned when touching the housing 901.

The airflow adjusting assembly 902 or the airflow path defined by the airflow adjusting assembly 902 may be configured to adjust at least one first airflow parameter of the airflow that enters the attachment 900 via the airflow inlet 907. Exemplary first airflow parameters of the airflow may include a flow rate, a velocity, a direction of the airflow at the airflow outlet, temperature, humidity, a composition of the airflow, etc. For example, with the airflow path narrowing gradually from the airflow inlet 907 to the airflow outlet (or the radiation outlet 906) of the airflow path of the attachment 900, the airflow entering the attachment 900 from the airflow inlet 907 of the attachment 900 may be converged and then exit the attachment 900 through the airflow outlet. Accordingly, the velocity of the airflow may increase.

Besides the inner wall, the airflow adjusting assembly 902 may include at least one additional adjusting component. For instance, the additional adjusting component may include at least one of a guiding surface 903 or a guiding wall 904.

The guiding surface 903 may be arranged in the airflow path of the attachment 900. As shown in FIGS. 9A and 9B, the guiding surface 903 may be arranged in a center region of the attachment 900 as viewed along the axial direction Z₅. The guiding surface 903 may have a shape of a duckbill including two openings at two ends along the axial direction Z₅. One opening of the guiding surface 903 may be located on a first end of the guiding surface 903 that (substantially) coincides with an end of the attachment 900 facing the drying apparatus 100. The other opening may be located on a second end of the guiding surface 903 facing the radiation outlet 906 (or referred to as airflow outlet). As described in connection with FIG. 5B, the guiding surface 903 may narrow gradually in a direction from the airflow inlet 907 to the airflow outlet (i.e., the axial direction Z₅) of the attachment 900. The guiding surface 903 may include an airflow channel 9031 through which at least a portion of the airflow traverses. Cross sections of the airflow channel 9031 may be configured to adjust at least one second airflow parameter of the at least a portion of the airflow. Exemplary second airflow parameters of the airflow may include a velocity, a direction, temperature, humidity, a composition, etc. of the airflow. For example, with the guiding surface 903 narrowing gradually, areas of the cross sections of the airflow channel 9031 may decrease gradually. The direction of the airflow may be adjusted (e.g., the airflow 504 being converged along the axial direction Z₅). Accordingly, the velocity of the airflow may be adjusted (e.g., increased).

The guiding surface 903 may be physically attached to a portion of the attachment 900. For instance, the guiding surface 903 may be physically attached to the inner wall of the housing 901 or the inner wall of the airflow adjusting assembly 902 through a rim 9032 and one or more connecting parts 9033. As exemplified in FIG. 9A, the guiding surface 903 may be physically connected with the rim 9032, and two ends of each of the connecting parts 9033 may physically connect the rim 9032 to the housing 901 of the attachment 900, respectively. The rim 9032 (e.g., an inner wall of the rim 9032) may define the airflow inlet 907. The rim 9032 (e.g., an outer wall of the rim 9032) and another portion of the attachment 900 (e.g., the inner wall of the housing 901 or the inner wall of the airflow adjusting assembly 902) may define the radiation inlet 905.

The guiding wall 904 may be arranged in the airflow channel 9031 of the guiding surface 903. As described in connection with FIG. 5A, the guiding wall 904 may have a tapered shape along the axial direction Z₅. A tip 9041 of the guiding wall 904 having the tapered shape may point to the airflow outlet (i.e., the radiation outlet 906). The guiding wall 904 may be configured to adjust at least one third airflow parameter (e.g., a velocity, a direction, temperature, humidity, a composition, etc.) of the airflow. For example, the airflow that traverses the airflow channel 9031 may move along the guiding wall 904 such that the direction of the airflow may be adjusted. The airflow may be converged along the axial direction Z₅. The velocity of the airflow in the airflow channel 9031 may be adjusted (e.g., increased). The guiding wall 904 may be physically connected to the guiding surface 903 through one or more connecting parts 9042. For example, two ends of each of the connecting parts 9042 may physically connect the guiding wall 904 to the inner wall of the rim 9032, respectively.

In some embodiments, the attachment 900 may include a radiation adjusting assembly (not shown). The radiation adjusting assembly may be configured to adjust at least one radiation parameter of the first radiation entering the attachment 900 such that second radiation may be output by the attachment 900 through the radiation outlet 906. As described in connection with FIG. 2, exemplary radiation parameters of the first radiation may include a radiation energy density, a radiation path, a radiation field distribution, spectrum, etc. In some embodiments, the at least one radiation parameter of the first radiation may be adjusted by the radiation adjusting assembly by a process including, e.g., reflection. For example, at least a portion of the radiation adjusting assembly may include a radiation-reflecting material. Exemplary radiation-reflecting materials may include a radiation-reflecting metal, a radiation-reflecting film, a radiation-reflecting coating, etc. At least a portion of the first radiation impinging on the radiation adjusting assembly may be reflected. For example, at least 50%, 60%, 70%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5%, 99.6%, 99.7%, 99.8%, 99.9%, etc., of the radiation impinging on the radiation adjusting assembly may be reflected.

In some embodiments, at least a portion of the radiation adjusting assembly may be arranged on a wall or surface located on a radiation path along which radiation travels within the attachment 900. For instance, at least a portion of the radiation adjusting assembly may be arranged on an inner surface of the airflow path defined by the airflow adjusting assembly 902, on the guiding surface 903, on the guiding wall 904, or the like, or a combination thereof. In some embodiments, at least a portion of the radiation adjusting assembly may be configured by constructing the airflow adjusting assembly 902, or a portion thereof (e.g., the guiding surface 903, on the guiding wall 904), using a material with a desired radiation related property. For instance, the guiding surface 903 may be constructed using a material with a desired radiation related property. Exemplary radiation related properties may include radiation reflecting, radiation refracting, radiation absorbing, radiation transmitting, radiation diffracting, radiation dispersing, waveguiding, etc.

In some embodiments, the radiation adjusting assembly may be a coating applied on the inner wall of the airflow adjusting assembly 902. As another example, the radiation adjusting assembly may include a film attached to the inner wall of the airflow adjusting assembly 902. In some embodiments, the radiation adjusting assembly that is arranged on the inner surface of the airflow path defined by the airflow adjusting assembly 902 may be located on a radiation path of the attachment 900 such that radiation impinges on the radiation adjusting assembly when traversing the attachment 900. The radiation adjusting assembly arranged on the airflow adjusting assembly 902 may face the radiation outlet 108 of the drying apparatus 100 to receive the first radiation generated by the drying apparatus 100. For example, a cross-sectional area of the at least a portion of the airflow adjusting assembly 902 with the radiation adjusting assembly arranged thereon may be (substantially) the same as or larger than a cross-sectional area of the radiation outlet of the drying apparatus 100. In some embodiments, the radiation power of the first radiation at the radiation inlet 905 may be at least 50%, 60%, 70%, 80%, 90%, 99.9%, etc., of the radiation power of the radiation generated by the radiation energy source assembly 104 of the drying apparatus 100. In some instances, the radiation power of the first radiation may be substantially 100% of the radiation power of the radiation generated by the radiation energy source assembly 104, meaning that substantially all the radiation generated by the radiation energy source assembly 104 enters the attachment 900.

In some embodiments, at least a portion of the radiation adjusting assembly may be arranged on the guiding surface 903. For example, at least a portion of the radiation adjusting assembly may be arranged on an outer wall of the guiding surface 903 facing an inner surface of the airflow path (or the inner wall of the airflow adjusting assembly 902). As another example, at least a portion of the radiation adjusting assembly may be arranged on the rim 9032 and/or the one or more connecting parts 9033. Merely by way of example, the radiation adjusting assembly may be arranged on a surface of each of the one or more connecting parts 9033 facing the radiation outlet 906. As another example, the radiation adjusting assembly may be arranged on an outer surface of the rim 9032. In some embodiments, the radiation adjusting assembly arranged on the guiding surface 903 may be configured such that radiation (e.g., radiation reflected by the radiation adjusting assembly arranged on the airflow adjusting assembly 902) impinging on the guiding surface 903 may be reflected in a certain direction (e.g., a direction towards the radiation outlet 906, a direction towards the inner wall of the airflow adjusting assembly 902). In some embodiments, the radiation adjusting assembly arranged on the airflow adjusting assembly 902, the guiding surface 903, the rim 9032, and/or the one or more connecting parts 9033 may cooperate with each other to process at least a portion of the first radiation by, e.g., reflection, so that a desired amount of the second radiation exits the attachment 900 through the radiation outlet 906. For example, radiation impinging on the airflow adjusting assembly 902 may be reflected to the guiding surface 903, the rim 9032, and/or the one or more connecting parts 9033 so that a desired amount of the second radiation exits the attachment 900 through the radiation outlet 906. In some embodiments, at least a portion of the radiation adjusting assembly may be arranged on the guiding wall 904. For example, at least a portion of the radiation adjusting assembly may be arranged on an outer wall of the guiding wall 904 on which the radiation (e.g., the radiation reflected by the inner wall of the airflow adjusting assembly 902) may impinge. Alternatively or additionally, the guiding surface 903 and/or the guiding wall 904 may include a radiation-permeable material such that at least a portion of the radiation impinging on the guiding surface 903 and the guiding wall 904 may pass through the guiding surface 903 and the guiding wall 904 so that a desired amount of the second radiation exits the attachment 900 through the radiation outlet 906.

In some embodiments, the radiation adjusting assembly may be configured such that (substantially) all radiation that impinges on the radiation adjusting assembly (and/or the airflow adjusting assembly 902) is reflected and (substantially) none or only a negligible amount converted to heat energy and therefore the temperature of the radiation adjusting assembly, and/or the temperature of airflow adjusting assembly 902, or a portion thereof (e.g. the guiding surface 903, the guiding wall 904), barely increases.

The connecting assembly 908 may be configured to operably connect the attachment 900 to the drying apparatus 100. For example, the attachment 900 may be removably attached to a component (e.g., the housing 101 or the wall 1024 as described in FIG. 1) of the drying apparatus 100 by the connecting assembly 908. Through the operable connection between the attachment 900 and the drying apparatus 100, at least a portion of the radiation and/or airflow generated by the drying apparatus 100 enters the attachment 900.

In some embodiments, the airflow adjusting assembly 902, including the guiding surface 903 and/or the guiding wall 904 as described in some embodiments, may be configured based on the airflow outlet 1022 of the drying apparatus 100. For example, a shape or a position of the airflow adjusting assembly 902 may be adjusted based on the airflow outlet 1022 of the drying apparatus 100 such that at least a portion of the airflow adjusting assembly 902 may be configured to adjust the at least one airflow parameter of the airflow that traverses the attachment 900. Merely by way of example, if the airflow outlet 1022 of the drying apparatus 100 is an annular region wrapping around the radiation outlet 108 of the drying apparatus 100, the guiding surface 903 and/or the guiding wall 904 may be arranged downstream to the annular region of the airflow outlet 1022 of the drying apparatus 100 for converging the airflow. As used herein, structure or region B being downstream to structure or region A indicates that the structure or region B and the structure or region A are arranged along a direction such that an airflow or radiation from the drying apparatus 100 passes through the structure or region A before the drying apparatus 100 passes through the structure or region B. The shape of the guiding surface 903 and/or the guiding wall 904 may be adjusted correspondingly, for example, from a duckbill to an annular structure extending circumferentially (continuously or intermittently). As another example, the guiding surface 903 and/or the guiding wall 904 may be omitted; the airflow may be converged by the airflow adjusting assembly 902 arranged inside the housing 901 directly.

In some embodiments, at least a portion of the radiation adjusting assembly of the attachment 900 may be configured based on the airflow outlet 1022 and/or the radiation outlet 108 of the drying apparatus 100. For example, a shape, a position, a count, or a radiation related property of the radiation adjusting assembly may be adjusted based on the airflow outlet 1022 and/or the radiation outlet 108 of the drying apparatus 100 to allow (substantially) all radiation entering the attachment 900 through the radiation inlet 905 may be converged along the axial direction Z₅ toward the radiation outlet 906 of the attachment 900. Merely by way of example, if the airflow outlet 1022 of the drying apparatus 100 is an annular region wrapping around the radiation outlet 108 of the drying apparatus 100, the guiding surface 903 and the guiding wall 904 may include a radiation-permeable material such that (substantially) all radiation that impinges on the guiding surface 903 and the guiding wall 904 may traverse the guiding surface 903 and the guiding wall 904, respectively, so that a desired amount of second radiation exits the attachment 900 through the radiation outlet 906.

With the attachment 900 illustrated in FIGS. 9A and 9B, the airflow that enters the attachment 900 through the airflow inlet 907 of the attachment 900 may be converged along the axial direction Z₅ toward the airflow outlet (or the radiation outlet 906) using the guiding surface 903, the guiding wall 904, the airflow path formed by the inner wall of the radiation adjusting assembly. In such cases, an airflow with an increased velocity may be output by the attachment 900. The first radiation that enters the attachment 900 through the radiation inlet 905 may be converged along the axial direction Z₅ toward the radiation outlet 906 of the attachment 900 such that second radiation may be output by the attachment 900 through the radiation outlet 906. The second radiation may have a higher radiation energy density than the first radiation. In some embodiments, a ratio of a radiation energy density of the second radiation to a radiation energy density of the first radiation may be in a range from 0.1-50, 0.3-40, 0.5-30, 0.7-20, 0.98-15, 1 to 12, 1.2 to 10, etc. Merely by way of example, the radiation energy density of the radiation provided by the drying apparatus 100 without the attachment 900 at a same position as the radiation outlet 906 of the attachment 900 may be from 5 kW/m² to 100 kW/m². The radiation energy density of the second radiation at the radiation outlet 906 of the attachment 900 may be from 10 kW/m² to 200 kW/m². The radiation field distribution of the first radiation may also be adjusted. For example, a total area of one or more patches of the second radiation exiting the radiation outlet 906 of the attachment 900 may be decreased, compared to a total area through which the first radiation enters the attachment 900 from the radiation inlet 905 of the attachment 900. In some embodiments, the radiation adjusting assembly may be configured to improve the degree of uniformity of the radiation energy density distribution of the second radiation (or referred to as the degree of uniformity of the second radiation) compared to the degree of uniformity of the radiation energy density distribution of the first radiation (or referred to as the degree of uniformity of the first radiation). For instance, the radiation energy density distribution of at least a portion of the one or more patches of the second radiation exiting the radiation outlet 906 of the attachment 900 may be substantially uniform. With the radiation adjusting assembly (e.g., the portion of the radiation adjusting assembly arranged on the inner wall of the airflow adjusting assembly 902, the portion of the radiation adjusting assembly arranged on the guiding surface 903, the portion of the radiation adjusting assembly arranged on the guiding wall 904, etc.), a significant portion of the radiation power of the first radiation may be output effectively by the attachment 900. In some embodiments, a ratio of the radiation power of the second radiation to the radiation power of the first radiation may be at least 1, 0.9, 0.8, 0.7, 0.6, 0.5, 0.4, 0.3, 0.2, etc. For example, the radiation power of the first radiation may be 100 W, and the radiation power of the second radiation may be larger than 30 W.

It should be noted that the above description is merely provided for the purposes of illustration, and not intended to limit the scope of the present disclosure. For persons having ordinary skills in the art, multiple variations and modifications may be made under the teaching of the present invention. However, those variations and modifications do not depart from the scope of the present disclosure. For example, one or more components (e.g., the guiding surface 903, the guiding wall 904, etc.) of the attachment may be omitted. As another example, the airflow adjusting assembly 902 may be omitted. The housing 901 may function as an airflow adjusting assembly directly. Correspondingly, at least a portion of the radiation adjusting assembly may be arranged on the inner wall of the housing 901 (e.g., as a radiation-reflecting coating or a radiation-reflecting film) directly.

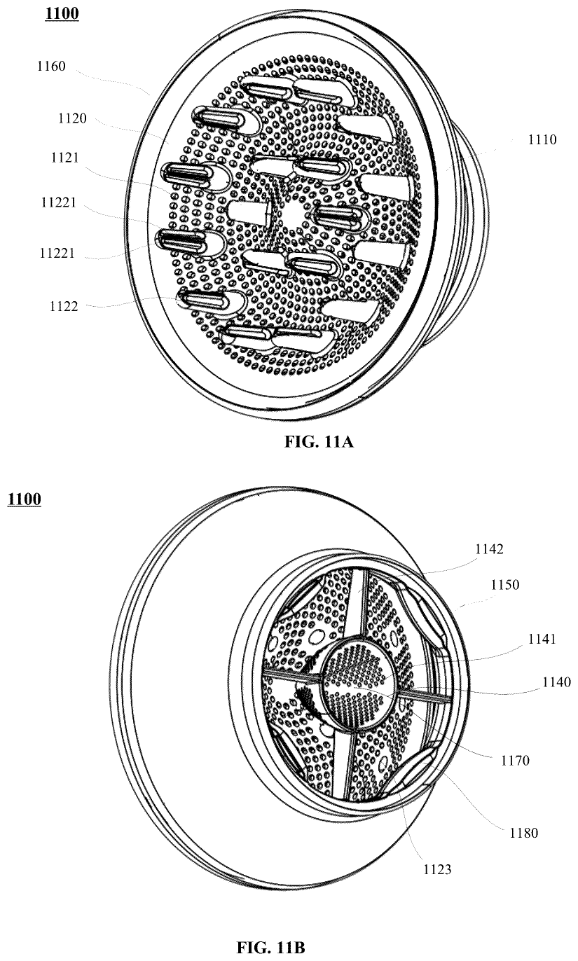

FIG. 10 provides a radial view of a radiation energy density distribution of the second radiation at the radiation outlet 906 of the attachment 900 illustrated in FIGS. 9A and 9B according to some embodiments of the present disclosure. The radial view may be perpendicular to the axial direction Z₅ of the attachment 900 illustrated in FIG. 9B (pointing into the paper as illustrated in FIG. 10). An area of a region 1001 in which the radiation energy density distribution was shown in FIG. 10 was the same as an area of a region 701 in which the radiation energy density distribution was shown in FIG. 7. As shown in FIG. 10, the second radiation exiting the radiation outlet 906 of the attachment 900 may include a patch 1002 located in a center region of the region 1001. A total area of the patch 1002 of the second radiation exiting the radiation outlet 906 of the attachment 900 may be decreased, compared to a total area of the one or more patches 702 of the radiation at the radiation outlet 108 of the drying apparatus 100 illustrated in FIG. 7A. In some embodiments, the radiation energy density distribution of the first radiation at the radiation inlet 905 of the attachment 900 may be substantially the same as the radiation energy density distribution at the radiation outlet of the 105 of the drying apparatus 100. The radiation energy density of the second radiation exiting the radiation outlet 906 of the attachment 900, especially in a center region (as indicated by a dashed circle C in FIG. 10) of the patch 1002, may be higher than the radiation energy density of the first radiation at a corresponding position in the region 701. That is, the first radiation that enters the attachment 900 through the radiation inlet 905 may be converged and the radiation energy density increased along the axial direction Z₅ toward the radiation outlet 906 of the attachment 900. In some embodiments, the radiation adjusting assembly may be configured such that the radiation energy density distribution of at least a portion of the patch 1002 of the second radiation exiting the radiation outlet 906 of the attachment 900 may be substantially uniform. For example, as illustrated in FIG. 10, the radiation energy density distribution in a region outside the dashed circle C in the patch 1002 is substantially uniform

FIGS. 11A-11C provide views of an exemplary attachment 1100 according to some embodiments of the present disclosure. In some embodiments, the attachment 1100 may be an exemplary embodiment of the attachment 200 described in FIG. 2. As shown in FIGS. 11A-11C, the attachment 1100 may include a housing 1110, a radiation-permeable cover 1120, an airflow adjusting assembly 1130, a grille 1140, a radiation inlet 1150, a radiation outlet 1160, an airflow inlet 1170, and a connecting assembly 1180.

Radiation (e.g., at least a portion of the radiation generated by the drying apparatus 100 illustrated in FIG. 1) may enter the attachment 1100 through the radiation inlet 1150 (or referred to as first radiation). An airflow (e.g., at least a portion of the airflow generated by the drying apparatus 100 illustrated in FIG. 1) may enter the attachment 1100 through the airflow inlet 1170.

The radiation inlet 1150 may be arranged around the airflow inlet 1170. In some embodiments, the radiation inlet 1150 of the attachment 1100 may be configured based on the radiation outlet 108 of the drying apparatus 100 such that the radiation inlet 1150 of the attachment 1100 and the radiation outlet 108 of the drying apparatus 100 may (substantially) coincide to allow (substantially) all radiation exiting the radiation outlet 108 of the drying apparatus 100 to enter the attachment 1100 through the radiation inlet 1150. For example, a shape, an orientation, a position, a cross-sectional area (a cross-sectional area viewed in an axial direction Z₆ of the attachment 1100 illustrated in FIG. 11C) of the radiation inlet 1150 of the attachment 1100 may be configured based on the radiation outlet 108 of the drying apparatus 100. Merely by way of example, the shape, the orientation, the position, and/or the cross-sectional area of the radiation inlet 1150 of the attachment 1100 may be configured such that the radiation inlet 1150 of the attachment 1100 and the radiation outlet 108 of the drying apparatus 100 may (substantially) coincide to allow (substantially) all radiation exiting the radiation outlet 108 of the drying apparatus 100 to enter the attachment 1100 through the radiation inlet 1150. In some embodiments, the airflow inlet 1170 of the attachment 1100 may be configured based on the airflow outlet 1022 of the drying apparatus 100 such that the airflow inlet 1170 of the attachment 1100 and the airflow outlet 1022 of the drying apparatus 100 may (substantially) coincide to allow (substantially) all airflow exiting the airflow outlet 1022 of the drying apparatus 100 to enter the attachment 1100 through the airflow inlet 1170.

In some embodiments, at least a portion of the radiation may exit the attachment 1100 through the radiation outlet 1160 (or referred to as second radiation). In some embodiments, at least a portion of the airflow may exit the attachment 1100 through the airflow outlet. In some embodiments, the radiation outlet 1160 and the airflow outlet of the attachment 1100 may at least partially overlap. For instance, the radiation outlet 1160 may be (substantially) coextensive with the airflow outlet of the attachment 1100; in other words, the radiation outlet 1160 may also function as the airflow outlet of the attachment 1100.

In some embodiments, the radiation outlet 1160 may be configured with a grille. For example, as shown in FIGS. 11A-11C, the radiation-permeable cover 1120 may be arranged at the radiation outlet 1160. The radiation-permeable cover 1120 may have a structure of a grille including a plurality of first openings 1121 and a plurality of columns 1122, each of which provides one or more second openings 11221. At least a portion of the airflow (e.g., an airflow generated by the drying apparatus 100 illustrated in FIG. 1) may exit the attachment 1100 through the plurality of first openings 1121 and second openings 11221.

The housing 1110 may enclose or provide mechanical support for one or more components (e.g., the radiation-permeable cover 1120, the airflow adjusting assembly 1130, etc.) of the attachment 1100. As shown in FIGS. 11A-11C, the housing 1110 may expand gradually in a direction from the radiation inlet 1150 to the radiation outlet 1160.

In some embodiments, the attachment 1100 may provide an airflow path along which an airflow in the attachment 1100 may travel. At least a portion of the airflow path may be defined by the airflow adjusting assembly 1130, or a portion thereof (e.g., an inner wall of the airflow adjusting assembly 1130). The airflow entering the attachment 1100 through the airflow inlet 1170 may traverse the attachment 1100 along the airflow path. The grille 1140 may be arranged at airflow inlet 1170 and extend into the airflow path of the attachment 1100. The airflow entering the attachment 1100 through the airflow inlet 1170 may traverse the grille 1140 and then the remaining portion of the attachment 1100 along the airflow path. In some embodiments, the airflow adjusting assembly 1130, including the grille 1140 and/or the radiation-permeable cover 1120 as described in some embodiments, may be configured to adjust at least one airflow parameter of the airflow that traverses the attachment 1100. Exemplary airflow parameters of the airflow may include a flow rate, a velocity, a direction of the airflow at the airflow outlet, temperature, humidity, a composition of the airflow, etc.

The airflow adjusting assembly 1130 may be arranged inside the housing 1110. For example, the airflow adjusting assembly 1130 may be physically attached to the housing 1110 at or in the vicinity of the airflow inlet 1170. As shown in FIG. 11C, an outer wall (or surface) of the airflow adjusting assembly 1130 may be substantially parallel to an inner wall (or surface) of the housing 1110. The airflow adjusting assembly 1130 or the airflow path defined by the airflow adjusting assembly 1130 may be configured to adjust at least one first airflow parameter of the airflow that traverses the attachment 1100. Exemplary first airflow parameters of the airflow may include a flow rate, a velocity, a direction of the airflow at the airflow outlet, temperature, humidity, a composition of the airflow, etc. For example, with the airflow path expanding gradually from the airflow inlet 1170 to the airflow outlet (or the radiation outlet 1160) of the airflow path of the attachment 1100, the airflow entering the attachment 1100 from the airflow inlet 1170 of the attachment 1100 may be diffused and then exit the attachment 1100 through the airflow outlet (e.g., through the first openings and/or the second openings on the radiation-permeable cover 1120). Accordingly, the velocity of the airflow may decrease.

Besides the inner wall, the airflow adjusting assembly 1130 may include at least one additional adjusting component. For instance, the additional adjusting component may include at least one of a radiation-permeable cover 1120 or a grille 1140.

The radiation-permeable cover 1120 may be arranged at the airflow outlet (or the radiation outlet 1160). As shown in FIGS. 11A-11C, the radiation-permeable cover 1120 may have a shape of a circle as viewed in a cross-sectional view of the attachment 1100 (e.g., a radial cross-sectional view perpendicular to the axial direction Z₆ of the attachment 1100 illustrated in FIG. 11). The radiation-permeable cover 1120 may be physically attached to the housing 1110 at or in the vicinity of the airflow outlet (or the radiation outlet 1160). The radiation-permeable cover 1120 may have a structure of a grille including a plurality of first openings 1121. At least a portion of the airflow that traverses the attachment 1100 may exit the attachment 1100 through the first openings 1121. The radiation-permeable cover 1120 may also include a plurality of column exits 1123. A plurality of columns 1122 may be configured at the corresponding column exits 1123. Each of the plurality of columns 1122 may be configured with one or more second openings 11221 for guiding at least a portion of the airflow exiting the attachment 1100 at an exit direction. In some embodiments, the exit directions of least two of the plurality of columns 1122 may be different. As shown in FIG. 11A, the radiation-permeable cover 1120 may include 6 columns 1122 located on an inner circle of the radiation-permeable cover 1120 and 12 columns 1122 located on an outer circle of the radiation-permeable cover 1120. Each column 1122 may include two second openings 11221. The two second openings 11221 of each of the 6 columns 1122 located in the inner circle may face the outer circle of the radiation-permeable cover 1120 such that the exit directions of the airflow exiting these columns 1122 may point to the outer circle. The two second openings 11221 of each of the 12 columns 1122 located on the outer circle may face the inner circle of the radiation-permeable cover 1120 such that the exit directions of the airflow exiting these columns 11222 may point to the inner circle. In such cases, the airflow exiting the attachment 1100 may be diffused in different directions and mix together so that the temperature of the airflow may become more uniform.

As shown in FIGS. 11B and 11C, the grille 1140 may be arranged in a center region of the attachment 1100 as viewed along the axial direction Z₆. The grille 1140 may be configured to adjust at least one second airflow parameter of the at least a portion of the airflow. Exemplary second airflow parameters of the airflow may include a velocity, a direction, temperature, humidity, a composition, etc. of the airflow. For example, as described in connection with FIG. 5C, the grille 1140 may have the shape of a cone including a network of openings 1141. The airflow may be blocked or interfered by the grille 1140 before exiting the grille 1140 through the network of openings 1141. In such cases, the velocity of the airflow may be adjusted (e.g., decreased and/or increased). In addition, the airflow may exit the grille 1140 through the network of openings 1141 in a plurality of directions. For example, the airflow exiting the grille 1140 may be guided toward a region of the radiation outlet 1160 and further exit the attachment 1100 through the plurality of first openings 1121 and the second openings 11221 of the radiation-permeable cover 1120.

The grille 1140 may be physically attached to a portion of the attachment 1100. For instance, the grille 1140 may be physically attached to the inner wall of the housing 1110 or the inner wall of the airflow adjusting assembly 1130 through one or more connecting parts 1142. As exemplified in FIG. 11B, two ends of each of the two connecting parts 1142 may physically connect the grille 1140 to the housing 1110 of attachment 1100, respectively. The grille 1140 (e.g., an inner wall of the grille 1140) may define the airflow inlet 1170. The grille 1140 (e.g., an outer wall of the grille 1140) and another portion of the attachment 1100 (e.g., the inner wall of the housing 1110 or the inner wall of the airflow adjusting assembly 1130) may define the radiation inlet 1150.

In some embodiments, the attachment 1100 may include a radiation adjusting assembly (not shown). The radiation adjusting assembly may be configured to adjust at least one radiation parameter of the first radiation entering the attachment 1100 through the radiation inlet 1150 to form second radiation output by the attachment 1100 through the radiation outlet 1160. Exemplary radiation parameters of the first radiation may include a radiation energy density, a radiation path, a radiation field distribution, spectrum, etc. In some embodiments, the at least one radiation parameter of the first radiation may be adjusted by the radiation adjusting assembly by a process including, e.g., transmission, reflection, absorbing, refraction, etc.

In some embodiments, at least a portion of the attachment 1100 may be configured as the radiation adjusting assembly. For example, radiation adjusting assembly may be arranged as an integral part of the attachment 1100. Merely by way of example, all the components of the attachment 1100 may include a radiation-permeable material. At least a portion of the first radiation that enters the attachment 1100 may traverse the attachment 1100. In some embodiments, at least a portion of the radiation adjusting assembly may be configured by constructing the at least a portion of the attachment 1100 (e.g., the radiation-permeable cover 1120, the grille 1140, or a portion thereof) using a material with a desired radiation related property. For instance, the radiation-permeable cover 1120 and/or the grille 1140 may be constructed using a radiation permeable material.

In some embodiments, the radiation-permeable cover 1120 may be configured as at least a portion of the radiation adjusting assembly. For example, the radiation-permeable cover 1120 may include a radiation-permeable material. Merely by way of example, the radiation-permeable cover 1120 may be made of a material having a high infrared transmissivity. At least a portion of the first radiation impinging on the radiation-permeable cover 1120 may traverse the radiation-permeable cover 1120. For example, at least 50%, 60%, 70%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5%, 99.6%, 99.7%, 99.8%, 99.9%, etc., of the radiation impinging on the radiation-permeable cover 1120 may traverse the radiation-permeable cover 1120. In some embodiments, the radiation-permeable cover 1120 may be configured such that (substantially) all radiation that impinges on the radiation-permeable cover 1120 may traverse the radiation-permeable cover 1120.

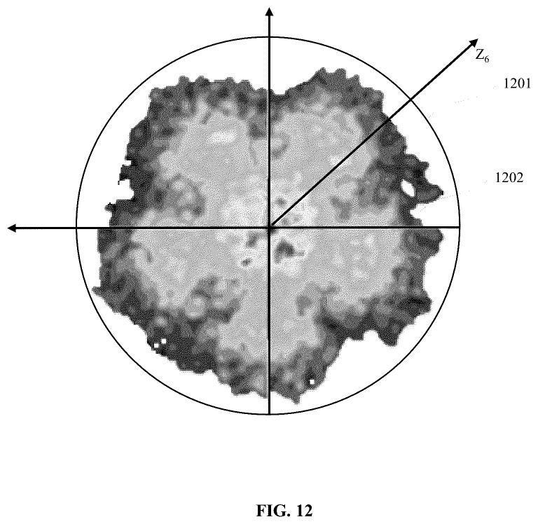

As shown in FIG. 11C, the radiation-permeable cover may have a uniform thickness. A portion D of the radiation-permeable cover 1120 may have a convex shape along the axial direction Z₆ of the attachment 1100. The portion D having the convex shape may be configured to receive the grille 1140 that has the shape of a cone. In some embodiments, the portion D may be configured based on a radiation field distribution (e.g., the radiation energy density distribution) of the second radiation at the radiation outlet 1160. For example, as described in connection with FIG. 1, the one or more radiation energy sources of the radiation energy source assembly 104 may be arranged along a ring. As illustrated in FIG. 12, the radiation energy density distribution of the first radiation at the radiation inlet 1150 may be non-uniform, having a higher radiation energy density in a center region of the radiation inlet 1150 than in a surrounding region of the radiation inlet 1150. The radiation energy density of the second radiation in the center region of the radiation outlet 1160 may be higher than in a surrounding region of the radiation outlet 1160. The portion D of the radiation-permeable cover 1120 may have the convex shape such that a travel path of the second radiation may be extended. Since the second radiation may attenuate gradually along the travel path, the radiation energy density at an outer surface of the portion D may be decreased, compared to the situation without the extended travel path created by the convex shape of the portion D. In some embodiments, the radiation-permeable cover 1120 may further include one or more portions E each of which has a concave shape. In some embodiments, the shape of the radiation-permeable cover 1120 may be configured such that the radiation energy density distribution at an outer surface of the radiation-permeable cover 1120 may be substantially uniform. As used herein, the outer surface of the radiation-permeable cover 1120 refers to a surface of the radiation-permeable cover 1120 that faces the object.

In some embodiments, at least a portion of the radiation-permeable cover 1120 may be located on a radiation path of the attachment 1100. A cross-sectional area of the radiation-permeable cover 1120 may be (substantially) larger than a cross-sectional area of the radiation outlet 108 of the drying apparatus 100. Correspondingly, the cross-sectional area of the radiation-permeable cover 1120 may be larger than a cross-sectional area of the radiation path of radiation generated by the radiation energy source assembly 104, meaning that substantially all the radiation generated by the radiation energy source assembly 104 traverses the radiation-permeable cover 1120. In some embodiments, radiation power of the first radiation at the radiation inlet 1150 may be at least 50%, 60%, 70%, 80%, 90%, 99.9%, etc., of the radiation power of the radiation generated by the radiation energy source assembly 104 of the drying apparatus 100. In some instances, the radiation power of the first radiation may be substantially 100% of the radiation power of the radiation generated by the radiation energy source assembly 104, meaning that substantially all the radiation generated by the radiation energy source assembly 104 enters the attachment 1100.

In some embodiments, the grille 1140 may be configured as at least a portion of the radiation adjusting assembly. For example, the grille 1140 may include a radiation-permeable material. In such cases, at least a portion of (e.g., substantially all) the radiation that impinges on the grille 1140 may traverse the grille 1140.

In some embodiments, the radiation adjusting assembly may be configured such that (substantially) all radiation that enters the attachment 1100 may traverse the radiation adjusting assembly (and/or the airflow adjusting assembly 1130) and (substantially) none or only a negligible amount may be converted to heat energy, and therefore the temperature of the radiation adjusting assembly, and/or the temperature of the airflow adjusting assembly 1130, or a portion thereof (e.g., the radiation-permeable cover 1120 and the grille 1140) barely increases.

In some embodiments, the radiation adjusting assembly may include a radiation-absorbing material. In some embodiments, the radiation adjusting assembly may be configured such that (substantially) all radiation that enters the attachment 1100 is absorbed. In some embodiments, the absorbed radiation may be converted into heat energy and therefore a temperature of the radiation adjusting assembly, and/or the temperature of the airflow adjusting assembly 1130, or a portion thereof, may increase. The heat energy may ultimately be transferred from the radiation adjusting assembly to the airflow such that a temperature of the airflow that traverses the attachment 1100 may increase accordingly. In some embodiments, at least a portion of the radiation may heat the airflow directly.

The connecting assembly 1180 may be configured to operably connect the attachment 1100 to the drying apparatus 100. For example, the attachment 1100 may be removably attached to a component (e.g., the housing 101 or the wall 1024 as described in FIG. 1) of the drying apparatus 100 by the connecting assembly 1180. Through the operable connection between the attachment 1100 and the drying apparatus 100, at least a portion of the radiation and/or airflow generated by the drying apparatus 100 may enter the attachment 1100.

In some embodiments, as described in connection with FIG. 2, the attachment 1100 may be removably attached to the drying apparatus 100 through a threaded connection, a buckle connection, a magnetic connection, a friction type connection, etc. For example, as shown in FIGS. 11A-11C, the connecting assembly 1180 of the attachment 1100 may include a magnet that attracts the connecting assembly 107 of the drying apparatus 100 including a ferromagnetic material or a magnet such that the attachment 1100 may be removably attached to the drying apparatus 100 through the magnetic connection. As another example, the connecting assembly 1180 of the attachment 1100 may include a ferromagnetic material that is attracted by the connecting assembly 107 of the drying apparatus 100 including a magnet such that the attachment 1100 may be removably attached to the drying apparatus 100 through the magnetic connection.

In some embodiments, the airflow adjusting assembly 1130, including the grille 1140 and/or the radiation-permeable cover 1120 as described in some embodiments, may be configured based on the airflow outlet 1022 of the drying apparatus 100. For example, a shape or a position of the airflow adjusting assembly 1130 may be adjusted based on the airflow outlet 1022 of the drying apparatus 100 such that the airflow adjusting assembly 1130 may adjust the at least one airflow parameter of the airflow that traverses the attachment 1100. Merely by way of example, if the airflow outlet 1022 of the drying apparatus 100 is an annular region wrapping around the radiation outlet 108 of the drying apparatus 100, the grille 1140 may be arranged downstream to the annular region of the airflow outlet 1022 of the drying apparatus 100 for diffusing the airflow. The shape of the grille 1140 may be adjusted correspondingly, for example, from a cone to an annular structure extending circumferentially (continuously or intermittently). The annular structure may include a network of openings 1141 in a plurality of directions. As another example, the attachment 1100 may include two or more grilles 1140 arranged along a circumference downstream to the annular region of the airflow outlet 1022 of the drying apparatus 100.

In some embodiments, at least a portion of the radiation adjusting assembly of the attachment 1100 may be configured based on the airflow outlet 1022 and/or the radiation outlet 108 of the drying apparatus 100. For example, a shape, a position, a count, or a radiation related property of the radiation adjusting assembly may be adjusted based on the airflow outlet 1022 and/or the radiation outlet 108 of the drying apparatus 100 to allow (substantially) all radiation entering the attachment 1100 through the radiation inlet 1150 may traverse or absorbed by the radiation adjusting assembly (and/or the airflow adjusting assembly 1130). Merely by way of example, if the airflow outlet 1022 of the drying apparatus 100 is an annular region wrapping around the radiation outlet 108 of the drying apparatus 100, the radiation field distribution (e.g., the radiation energy density distribution) of the radiation may vary in a cross-section perpendicular to the Z₆ direction. In such cases, a shape of the radiation-permeable cover 1120 may be adjusted accordingly such that the radiation energy density distribution at an outer surface of the radiation-permeable cover 1120 may be substantially uniform.

With the attachment 1100 illustrated in FIGS. 11A-11C, the airflow that enters the attachment 1100 through the airflow inlet 1170 may be defused by the grille 1140 and the radiation-permeable cover 1120 configured as a grille. In such cases, an airflow with a decreased velocity may be output by the attachment 1100 in different directions. The first radiation may traverse the attachment 1100 such that second radiation may be output by the attachment 1100 through the radiation outlet 1160. The radiation adjusting assembly (e.g., the grille 1140, the radiation-permeable cover 1120) may include a radiation-permeable material such that at least 50%, 60%, 70%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5%, 99.6%, 99.7%, 99.8%, 99.9%, etc., of the first radiation may traverse the attachment 1100. In some embodiments, a ratio of a radiation energy density of the second radiation to a radiation energy density of the first radiation may be in a range from 0.1 to 10, 0.2 to 8, 0.3 to 5, 0.4 to 3, 0.5 to 2, 0.5 to 1.5, etc. Merely by way of example, the radiation energy density of the first radiation provided by the drying apparatus 100 without the attachment 1100 at a same position as the radiation outlet 1160 of the attachment 1100 may be from 5 kW/m² to 100 kW/m². And the radiation energy density of the second radiation at the radiation outlet 1160 of the attachment 1100 may be from 5 kW/m² to 100 kW/m². In some embodiments, a degree of uniformity of the radiation energy density distribution of the second radiation (or referred to as a degree of uniformity of the second radiation for brevity) may be improved over a degree of uniformity of the first radiation that enters the attachment 1100. With the radiation adjusting assembly, a significant portion of the radiation power of the first radiation may be output effectively by the attachment 1100. In some embodiments, a ratio of the radiation power of the second radiation to the radiation power of the first radiation may be at least 1, 0.9, 0.8, 0.7, 0.6, 0.5, etc. For example, the radiation power of the first radiation may be 100 W, and the radiation power of the second radiation may be larger than 50 W, or substantially the same as the radiation power of the first radiation. Alternatively or additionally, the radiation adjusting assembly may include a radiation-absorbing material. At least a portion of the radiation may be absorbed to heat the airflow that traverses the attachment 1100 such that an airflow with an increased temperature may be output by the attachment 1100.

It should be noted that the above description is merely provided for the purposes of illustration, and not intended to limit the scope of the present disclosure. For persons having ordinary skills in the art, multiple variations and modifications may be made under the teaching of the present invention. However, those variations and modifications do not depart from the scope of the present disclosure. For example, one or more components (e.g., the grille 1140) of the attachment 1100 may be omitted. As another example, the airflow adjusting assembly 1130 may be arranged on the inner wall of the housing 1110 directly. Merely by way of example, the airflow adjusting assembly 1130 may be omitted. The airflow path may be formed by the inner wall of the housing 1110. In such cases, the housing 1110 may function as an airflow adjusting assembly.

FIG. 12 provides a radial view of a radiation energy density distribution of the second radiation at the radiation outlet 1160 of the attachment 1100 illustrated in FIGS. 11A-11C according to some embodiments of the present disclosure. The radial view may be perpendicular to the axial direction Z₆ of the attachment 1100 illustrated in FIG. 11C. An area of a region 1201 in which the radiation energy density distribution was shown in FIG. 12 was the same as an area of a region 701 was obtained. As shown in FIG. 12, the second radiation exiting the radiation outlet 1160 of the attachment 1100 may include a patch 1202 located in a center region of the region 1201. A total area of the patch 1202 was larger than a total area of the one or more patches 702 of the radiation exiting the radiation outlet 108 of the drying apparatus 100. In some embodiments, the first radiation at the radiation inlet 1150 of the attachment 1100 may be substantially the same as the radiation energy density distribution at the radiation outlet of the 105 of the drying apparatus 100. A degree of uniformity of the radiation energy density distribution of the second radiation (or referred to as a degree of uniformity of the second radiation for brevity) in the patch 1202 is improved over a degree of uniformity of the first radiation in the one or more patches 702.

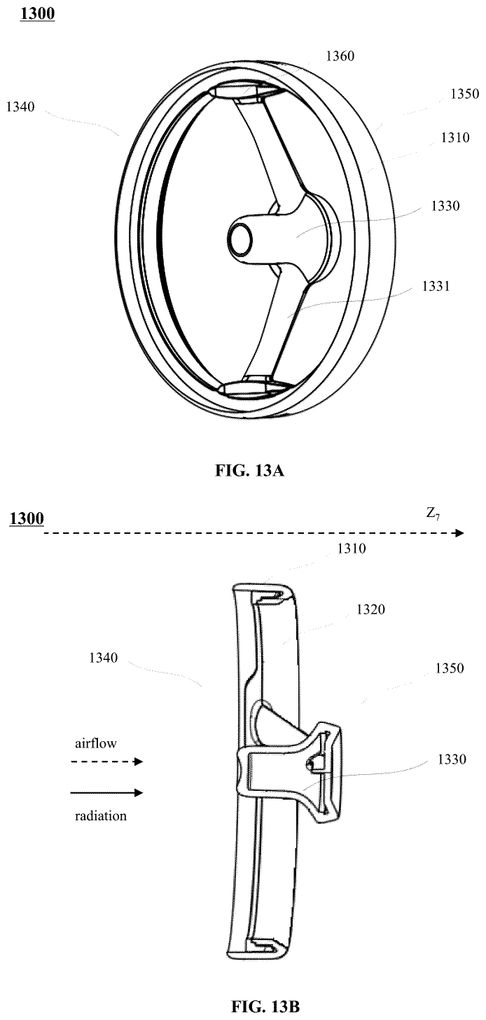

FIGS. 13A and 13B provide views of an exemplary attachment 1300 according to some embodiments of the present disclosure. In some embodiments, the attachment 1300 may be an exemplary embodiment of the attachment 200 described in FIG. 2. As shown in FIGS. 13A and 13B, the attachment 1300 may include a housing 1310, an airflow adjusting assembly 1320, a guiding column 1330, an airflow inlet 1340, an airflow outlet 1350, and a connecting assembly 1360.

An airflow (e.g., at least a portion of the airflow generated by the drying apparatus 100 illustrated in FIG. 1) may enter the attachment 1300 through the airflow inlet 1340. In some embodiments, the airflow inlet 1340 of the attachment 1300 may be configured based on the airflow outlet 1022 of the drying apparatus 100 such that the airflow inlet 1340 of the attachment 1300 and the airflow outlet 1022 of the drying apparatus 100 may (substantially) coincide to allow (substantially) all the airflow exiting the airflow outlet 1022 of the drying apparatus 100 to enter the attachment 1300 through the airflow inlet 1340. For example, a shape, an orientation, a position, a cross-sectional area (a cross-sectional area viewed in an axial direction Z₇ of the attachment 1300 illustrated in FIG. 13B) of the airflow inlet 1340 of the attachment 1300 may be configured based on the airflow outlet 1022 of the drying apparatus 100 such that the airflow inlet 1340 of the attachment 1300 and the airflow outlet 1022 of the drying apparatus 100 may substantially coincide to allow (substantially) all the airflow exiting the airflow outlet 1022 of the drying apparatus 100 to enter the attachment 1300 through the airflow inlet 1340. In some embodiments, at least a portion of the airflow may exit the attachment 1300 through the airflow outlet 1350.

Radiation (e.g., at least a portion of the radiation generated by the drying apparatus 100 illustrated in FIG. 1) may enter the attachment 1300 through a radiation inlet (or referred to as first radiation). In some embodiments, the radiation inlet and the airflow inlet 1340 of the attachment 1300 may at least partially overlap. For instance, the radiation inlet may be (substantially) coextensive with the airflow inlet 1340 of the attachment 1300; in other words, the airflow inlet 1340 may also function as a radiation inlet.

In some embodiments, at least a portion of the radiation may exit the attachment 1300 through a radiation outlet (or referred to as second radiation). The airflow outlet 1350 and the radiation outlet may at least partially overlap. For instance, the airflow outlet 1350 may be (substantially) coextensive with the radiation outlet of the attachment 1300; in other words, the airflow outlet 1350 may also function as a radiation outlet.

The housing 1310 may enclose or provide mechanical support for one or more components (e.g., the airflow adjusting assembly 1320, and/or the guiding column 1330) of the attachment 1300.

In some embodiments, the attachment 1300 may provide an airflow path along which an airflow in the attachment 1300 may travel. At least a portion of the airflow path may be defined by the airflow adjusting assembly 1320, or a portion thereof (e.g., an inner wall of the airflow adjusting assembly 1320). The airflow entering the attachment 1300 through the airflow inlet 1340 may traverse the attachment 1300 along the airflow path. In some embodiments, the airflow adjusting assembly 1320, including the grille 1140 as described in some embodiments, may be configured to adjust at least one airflow parameter of the airflow that traverses the attachment 1100. Exemplary airflow parameters of the airflow may include a flow rate, a velocity, a direction of the airflow at the airflow outlet, temperature, humidity, a composition of the airflow, etc.

The airflow adjusting assembly 1320 may be arranged inside the housing 1110. For example, as shown in FIG. 13B, an inner wall of the attachment 1300 (or an inner wall of the housing 1310) may function as the airflow adjusting assembly 1320. As another example, the airflow adjusting assembly 1320 may be physically attached to the housing 1310 at or in the vicinity of the airflow inlet 1340. The airflow adjusting assembly 1320 or the airflow path defined by the airflow adjusting assembly 1320 may be configured to adjust at least one first airflow parameter of the airflow that traverses the attachment 1300. Exemplary first airflow parameters of the airflow may include a flow rate, a velocity, a direction of the airflow at the airflow outlet, temperature, humidity, a composition of the airflow, etc.

In some embodiments, the airflow adjusting assembly 1320 may further include the guiding column 1330 (or an airflow adjusting sub-assembly). For example, the guiding column 1330 may be arranged in the airflow path formed by the inner wall of the attachment 1300. The guiding column 1330 may be configured to adjust at least one second airflow parameter of the airflow that enters the attachment 1300. Exemplary second airflow parameters of the airflow may include a velocity, a direction, temperature, humidity, a composition, etc. of the airflow. As shown in FIGS. 13A and 13B, the guiding column 1330 may be arranged in a center region of the attachment 1300 as viewed along the axial direction Z₇. As described in connection with FIG. 5D, the guiding column 1330 may include a surface expanding gradually in a direction from the airflow inlet to the airflow outlet (e.g., along the axial direction Z₇). At least a portion of the airflow may move along the surface of the guiding column 1330 such that the direction of the airflow may be adjusted. For example, the least a portion of the airflow may move toward the inner wall of the housing 1310 along the guiding column 1330 such that the airflow may be diffused. In addition, at least a portion of the airflow may be blocked or interfered by the guiding column 1330. Accordingly, the velocity of the airflow may be adjusted (e.g., decreased). The guiding column 1330 may be physically attached to a portion of the attachment 1300. For instance, the guiding column 1330 may be physically attached to the inner wall of the housing 1310 through one or more connecting parts 1331. Two ends of each of the connecting parts 1331 may physically connect the guiding column 1330 to the attachment 1300, respectively.

In some embodiments, the attachment 1300 may include a radiation adjusting assembly (not shown). The radiation adjusting assembly may be configured to adjust at least one radiation parameter of the first radiation entering the attachment 1300 such that second radiation may be output by the attachment 1300 through the airflow outlet 1350. As described in connection with FIG. 2, exemplary radiation parameters of the first radiation may include a radiation energy density, a radiation path, a radiation field distribution, spectrum, etc.

In some embodiments, the radiation adjusting assembly may be configured such that (substantially) all radiation that impinges on the airflow adjusting assembly 1320, or a portion thereof (e.g., the inner wall of the housing 1310, the guiding column 1330), is reflected or traverse the attachment 1300 and (substantially) none or only a negligible amount converted to heat energy and therefore the temperature of the radiation adjusting assembly and/or the temperature of the airflow adjusting assembly 1320, or a portion thereof (e.g., the inner wall of the housing 1310, the guiding column 1330) barely increases.

In some embodiments, the radiation adjusting assembly may include radiation-absorbing material. In some embodiments, the radiation adjusting assembly may be configured such that (substantially) all radiation that enters the attachment 1300 is absorbed. In some embodiments, the absorbed radiation may be converted into heat energy and therefore a temperature of the radiation adjusting assembly, and/or the temperature of the airflow adjusting assembly 1320, or a portion thereof may increase. The heat energy may be ultimately transferred from the radiation adjusting assembly to the airflow such that a temperature of the airflow that traverses the attachment 1300 may increase accordingly. In some embodiments, at least a portion of the radiation may heat the airflow directly.

In some embodiments, at least a portion of the radiation adjusting assembly may be arranged on a surface of the airflow adjusting assembly 1320 (e.g., the inner wall of the housing 1310, a surface of the guiding column 1330, and/or surfaces of the one or more connecting parts 1331). The at least a portion of the radiation adjusting assembly arranged on a surface of the airflow adjusting assembly 1320 may include a radiation-reflecting material coated on the surface of the airflow adjusting assembly 1320. The surface of the airflow adjusting assembly 1320 on which the at least a portion of the radiation adjusting assembly is arranged may be located on the radiation path in the attachment 1300. The surface of the airflow adjusting assembly 1320 on which the at least a portion of the radiation adjusting assembly is arranged may face the radiation energy source assembly 104 of the drying apparatus. In such cases, radiation impinging on the surface of the airflow adjusting assembly 1320 may be reflected. In some embodiments, the radiation impinging on the surface of the airflow adjusting assembly 1320 may be substantially 100% reflected by the radiation adjusting assembly arranged on the surface of the airflow adjusting assembly 1320, meaning that none or only a negligible amount of radiation is converted to heat energy and therefore the temperature of the airflow adjusting assembly 1320, or a portion thereof (e.g., the guiding column 1330, the one or more connecting parts 1331) barely increases. In some embodiments, the at least a portion of the radiation adjusting assembly arranged on a surface of the airflow adjusting assembly 1320 may include a radiation-absorbing material coated on the surface of the airflow adjusting assembly 1320. For example, the radiation-absorbing material may be coated on the airflow adjusting assembly 1320 arranged on the inner wall of the housing 1310. The airflow adjusting assembly 1320 on which the at least a portion of the radiation adjusting assembly is arranged may face the radiation energy source assembly 104 of the drying apparatus 100. In such cases, radiation impinging on the surface of the airflow adjusting assembly 1320 arranged on the inner wall of the housing 1310 may be absorbed to heat the airflow that traverses the attachment 1300. Alternatively or additionally, a space may be arranged between the inner wall of the housing 1310 and the outer wall of the airflow adjusting assembly 1320. The space may separate the airflow adjusting assembly 1320 from the housing 1310, thereby preventing or reducing the temperature increase in the housing 1310, which in turn may reduce the risk that a user is burned when touching the housing 1310.

In some embodiments, at least a portion of the radiation adjusting assembly may be arranged as an integral part of the attachment 1300. For example, at least a portion of the airflow adjusting assembly 1320 (e.g., the guiding column 1330, and/or the one or more connecting parts 1331) may include a radiation-permeable material. The at least a portion of the airflow adjusting assembly 1320 including the radiation-permeable material may be located on the radiation path of the attachment 1300. In such cases, radiation may traverse at least a portion of the airflow adjusting assembly 1320. In some instances, the radiation may substantially 100% traverse the airflow adjusting assembly 1320, meaning that none or only a negligible amount of radiation is converted to heat energy and therefore the temperature of the airflow adjusting assembly 1320 barely increases.

The connecting assembly 1360 may be configured to operably connect the attachment 1300 to the drying apparatus 100. For example, the attachment 1300 may be removably attached to a component (e.g., the housing 101 or the wall 1024 as described in FIG. 1) of the drying apparatus 100 by the connecting assembly 1360. Through the operable connection between the attachment 1300 and the drying apparatus 100, at least a portion of the radiation and/or airflow generated by the drying apparatus 100 may enter the attachment 1300.

In some embodiments, the airflow adjusting assembly 1320, including the guiding column 1330 as described in some embodiments, may be configured based on the airflow outlet 1022 of the drying apparatus 100. For example, a shape or a position of the airflow adjusting assembly 1320 may be adjusted based on the airflow outlet 1022 of the drying apparatus 100 such that the airflow adjusting assembly 1320 may adjust the at least one airflow parameter of the airflow that traverses the attachment 1300. Merely by way of example, if the airflow outlet 1022 of the drying apparatus 100 is an annular region wrapping around the radiation outlet 108 of the drying apparatus 100, the guiding column 1330 may be arranged downstream to the annular region of the airflow outlet 1022 of the drying apparatus 100 for diffusing the airflow. The shape of the guiding column 1330 may be adjusted correspondingly, for example, from a column to an annular structure extending circumferentially (continuously or intermittently). The annular structure may include a surface expanding gradually in the direction from the airflow inlet to the airflow outlet (e.g., along the axial direction Z₇). As another example, the attachment 1300 may include two or more guiding columns 1330 arranged along a circumference downstream to the annular region of the airflow outlet 1022 of the drying apparatus 100.

In some embodiments, at least a portion of the radiation adjusting assembly of the attachment 1300 may be configured based on the airflow outlet 1022 and/or the radiation outlet 108 of the drying apparatus 100. For example, a shape, a position, a count, or a radiation related property of the radiation adjusting assembly may be adjusted based on the airflow outlet 1022 and/or the radiation outlet 108 of the drying apparatus 100 to allow (substantially) all radiation entering the attachment 1300 through the radiation inlet may traverse, be reflected, refracted, diffracted, dispersed, waveguided, or absorbed by the radiation adjusting assembly (and/or the airflow adjusting assembly 1320).

In some embodiments, as described in connection with FIG. 2, the attachment 1300 may be removably attached to the drying apparatus 100 through a threaded connection, a buckle connection, a magnetic connection, a friction type connection, etc. For example, as shown in FIGS. 13A and 13B, the connecting assembly 1360 of the attachment 1300 may include a magnet that attracts the connecting assembly 107 of the drying apparatus 100 including a ferromagnetic material or a magnet such that the attachment 1300 may be removably attached to the drying apparatus 100 through the magnetic connection. As another example, the connecting assembly 1360 of the attachment 1300 may include a ferromagnetic material that is attracted by the connecting assembly 107 of the drying apparatus 100 including a magnet such that the attachment 1300 may be removably attached to the drying apparatus 100 through the magnetic connection.

With the attachment 1300 illustrated in FIGS. 13A and 13B, the airflow that enters the attachment 1300 through the airflow inlet may be diffused by the guiding column 1330. A diffused airflow with a decreased velocity may be output by the attachment 1300. The first radiation that enters the attachment 1300 through the airflow inlet 1340 may traverse the attachment 1300 with a significant amount of the first radiation output by the attachment 1300 through the airflow outlet 1350 as the second radiation. In some embodiments, a ratio of the radiation power of the second radiation to the radiation power of the first radiation may be at least 1, 0.9, 0.8, etc. For example, the radiation power of the first radiation may be 100 W, and the radiation power of the second radiation may be larger than 80 W. In some embodiments, a portion of the radiation that enters the attachment 1300 may be reflected by the radiation adjusting assembly when the radiation adjusting assembly includes radiation-reflecting material arranged on the surface of the airflow adjusting assembly 1320. In such cases, a direction of the radiation may be adjusted.

It should be noted that the above description is merely provided for the purposes of illustration, and not intended to limit the scope of the present disclosure. For persons having ordinary skills in the art, multiple variations and modifications may be made under the teaching of the present invention. However, those variations and modifications do not depart from the scope of the present disclosure. For example, radiation adjusting assembly may be configured to adapt to the needs of different scenarios. Merely by way of example, the radiation adjusting assembly may include a waveguide configured to guide at least a portion of the radiation to a desired position of an object.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. An attachment configured to be operably coupled to a drying apparatus that includes a radiation energy source assembly, the attachment having a radiation inlet and a radiation outlet, comprising:
a radiation adjusting assembly configured to output second radiation through the radiation outlet by adjusting at least one radiation parameter of first radiation, wherein
the first radiation is generated by the radiation energy source assembly of the drying apparatus and enters the attachment through the radiation inlet, and
a radiation power of the first radiation is at least 5 watts.

2. The attachment of claim 1, wherein the at least one radiation parameter of the first radiation includes at least one of: a radiation energy density, a radiation path, a radiation field distribution, or spectrum.

3. The attachment of claim 1, wherein the at least one radiation parameter of the first radiation is adjusted by the radiation adjusting assembly by a process including at least one of: reflection, refraction, absorption, transmission, diffraction, dispersion, or waveguiding.

4. The attachment of claim 1, wherein
the drying apparatus further includes an airflow generating assembly configured to generate an airflow, and
the attachment further includes an airflow adjusting assembly, wherein
the airflow adjusting assembly is configured to provide an airflow path having an airflow inlet and an airflow outlet, or
the airflow adjusting assembly includes an airflow guiding sub-assembly.

5. The attachment of claim 4, wherein
at least one of the airflow path or the airflow adjusting assembly is configured to adjust at least one first airflow parameter of the airflow that enters the attachment via the airflow inlet; and/or
the airflow guiding sub-assembly is configured to adjust at least one second airflow parameter of the airflow.

6. The attachment of claim 4, wherein at least a portion of the first radiation is consumed to heat the airflow.

7. The attachment of claim 6, wherein the at least a portion of the first radiation is consumed to heat the airflow by a process including at least one of reflection or absorption.

8. The attachment of claim 4, wherein the radiation adjusting assembly is arranged on an inner wall of the attachment.

9. The attachment of claim 8, wherein at least a portion of the radiation adjusting assembly is arranged on an inner surface of the airflow path.

10. The attachment of claim 4, wherein
at least a portion of the radiation adjusting assembly is arranged on an inner surface of the airflow path, or
at least a portion of the radiation adjusting assembly is arranged on an outer wall of the airflow guiding sub-assembly facing an inner surface of the airflow path,
wherein the at least a portion of the radiation adjusting assembly includes a radiation-reflecting material.

11. The attachment of claim 4, wherein the radiation adjusting assembly is arranged as an integral part of the attachment.

12. The attachment of claim 11, wherein the radiation adjusting assembly includes a radiation-permeable cover arranged at the radiation outlet.

13. The attachment of claim 12, wherein the airflow guiding sub-assembly includes a grille for guiding at least a portion of the airflow toward a region of the radiation outlet.

14. The attachment of claim 12, wherein the radiation-permeable cover includes a plurality of first openings for guiding at least a portion of the airflow exiting the attachment.

15. The attachment of claim 12, wherein the radiation-permeable cover includes a plurality of columns each of which provides a second opening for guiding at least a portion of the airflow exiting the attachment at an exit direction.

16. The attachment of claim 4, wherein at least a portion of the radiation adjusting assembly is arranged on a surface of the airflow guiding sub-assembly, and the surface of the airflow guiding sub-assembly on which the at least a portion of the radiation adjusting assembly is arranged is located on a radiation path of the first radiation.

17. The attachment of claim 16, wherein
the surface of the airflow guiding sub-assembly on which the at least a portion of the radiation adjusting assembly is arranged faces the radiation energy source assembly; and/or
the at least a portion of the radiation adjusting assembly includes a radiation-reflecting material coated on the surface of the airflow guiding sub-assembly.

18. The attachment of claim 4, wherein at least a portion of the airflow guiding sub-assembly includes a radiation-permeable material, and the at least a portion of the airflow guiding sub-assembly is located on a radiation path of the first radiation.

19. The attachment of claim 1, further comprising a connecting assembly configured to operably connect the attachment to the drying apparatus, wherein
the attachment is attached to a housing of the drying apparatus by the connecting assembly; and/or
the connecting assembly includes a magnet.

20. A drying apparatus, comprising:
a radiation energy source assembly configured to provide first radiation; and
an attachment having a radiation inlet and a radiation outlet, comprising:
a radiation adjusting assembly configured to output second radiation through the radiation outlet by adjusting at least one radiation parameter of the first radiation, wherein
the first radiation enters the attachment through the radiation inlet, and
a radiation power of the first radiation is at least 5 watts.
